(19) United States
(12) Patent Application Publication
(10) Pub. No.: US 2026/0295833 A1
(43) Pub. Date: Oct. 1, 2026

(54) SYSTEM INCLUDING MULTI-SEGMENTED ROBOTIC ARM ASSEMBLY CONFIGURED TO SYNCHRONOUSLY MOVE END EFFECTOR HAVING WRITING INSTRUMENT TO DRAW PATTERN ON WORK OBJECT AND METHOD THEREOF

(71) Applicant: Precision Steel Systems, LLC, Lincoln, NE (US)

(72) Inventors: Nicholas Donner, Lincoln, NE (US); Robert Gaskins, Cass Lake, MN (US)

(21) Appl. No.: 19/094,800

(22) Filed: Mar. 28, 2025

(51) Int. Cl. B25J 9/16; B25J 9/00; B25J 9/12; B25J 18/00; B65G 47/90

(52) U.S. Cl. CPC B25J 9/1664; B25J 9/0093; B25J 9/0096; B25J 9/12; B25J 9/1666; B25J 18/00; B65G 47/90; G05B 2219/35292; G05B 2219/39521; G05B 2219/40083

(57) ABSTRACT

A system for imparting a pattern of the surface of a work object, comprising a plurality of arm segments, an arm base assembly, an end effector, a plurality of actuators, and at least one processor. The plurality of arm segments comprising: a plurality of joints allowing the arm segments to move with at least one degree of freedom. The arm base assembly is configured to travel along a structure. The end effector is connected to a terminal arm segment of the plurality of arm segments and comprises a writing instrument. The plurality of actuators collectively configured to: move and rotate the plurality of arm segments and the arm base assembly. The processor configured to: access data associated with a design; and output at least one of instructions that cause the plurality of actuators to collectively move the tip of the writing instrument along the surface of the work object.

### BACKGROUND

Current automated machines for performing a process of applying a layout pattern to a flat work surface, such as a plate of steel, are heavy, are expensive, occupy a large foot-print and volume, require and fixedly incorporate a wide and very long version of the flat work surface that is not easily modified, and are only able to apply a layout pattern to a flat work surface. Additionally, such current automated machines are prone to causing a phase of applying the layout pattern of a multi-phased project to be a bottleneck that limits overall production throughput because even after the layout pattern is drawn on the automated machine’s integrated work surface, the automated machine must wait for a completion of an assembly of components over the layout pattern and a subsequent cleaning of the automated machine’s integrated work surface before such automated machine can begin applying another layout pattern on the work surface.

### SUMMARY

In some aspects, the techniques described herein relate to a system, including: a plurality of arm segments including a first arm segment, a second arm segment, and a terminal arm segment, wherein each arm segment of the plurality of arm segments is connected, via at least one arm segment joint, to at least one adjacent arm segment of the plurality of arm segments, wherein each of said at least one arm segment joints allows a given arm segment of the plurality of arm segments to move with at least one degree of freedom relative to a given adjacent arm segment that is adjacent the given arm segment, wherein said at least one arm segment joints includes a first arm segment joint and a terminal arm segment joint, wherein the first arm segment joint connects the first arm segment and the second arm segment, wherein the terminal arm segment connects at the terminal arm segment joint; an arm base assembly including a first arm base component and a second arm base component, wherein the arm base assembly is configured to travel along a structure, wherein the first arm base component is connected, via an arm base joint, to the second arm base component, wherein the arm base joint allows the second arm base component to move with at least one degree of freedom relative to the first arm base component, wherein the second arm base component is connected, via a joint, to the first arm segment, wherein the joint allows the first arm segment to move with at least one degree of freedom relative to the second arm base component; an end effector connected to the terminal arm segment, the end effector including a writing instrument having a tip; a plurality of actuators collectively configured at least to: move the arm base assembly along the structure; rotate the second arm base component relative to the first arm base component about a first axis passing through the second arm base component and the first arm base component; move the first arm segment relative to the second arm base component about a second axis passing through the joint, wherein the first axis and the second axis are non-parallel; move the second arm segment about a third axis passing through the first arm segment joint; and move the terminal arm segment about a fourth axis passing through the terminal arm segment joint; and at least one processor communicatively coupled at least with the plurality of actuators, wherein the at least one processor is configured to: access data associated with a design; and output at least one of instructions or signals that cause the plurality of actuators to collectively move the tip of the writing instrument along a three-dimensional path relative to a position of and an orientation of a work object such that the tip of the writing instrument interacts with the work object in accordance with the design to draw a pattern on a surface of the work object, the pattern corresponding to the design.

It is to be understood that both the foregoing general description and the following detailed description are exemplary and explanatory only and should not restrict the scope of the claims. The accompanying drawings, which are incorporated in and constitute a part of the specification, illustrate exemplary embodiments of the inventive concepts disclosed herein and together with the general description, serve to explain the principles.

### BRIEF DESCRIPTION OF THE DRAWINGS

The numerous advantages of the embodiments of the inventive concepts disclosed herein may be better understood by those skilled in the art by reference to the accompanying figures in which:

FIG. 1 is a block diagram of a system for controlling a robotic arm assembly according to example embodiments of this disclosure;

FIG. 2A depicts an isometric view of an exemplary control panel for controlling a robotic arm assembly according to example embodiments of this disclosure;

FIG. 2B depicts an isometric view of a display of the exemplary control panel displaying a first position of a plurality of arm segments of the robotic arm assembly according to example embodiments of this disclosure;

FIG. 2C depicts an isometric view of a display of the exemplary control panel displaying a second position of the plurality of arm segments of the robotic arm assembly according to example embodiments of this disclosure;

FIG. 2D depicts a table listing a field or data stream defining movement of the plurality of arm segments of the robotic arm assembly according to example embodiments of this disclosure;

FIG. 2E depicts an isometric view of the display of the exemplary control panel displaying a first pattern to be drawn on the surface of a work object by the robotic arm assembly according to example embodiments of this disclosure;

FIG. 2F depicts an isometric view of the display of the exemplary control panel displaying a second pattern to be drawn on the surface of a work object by the robotic arm assembly according to example embodiments of this disclosure;

FIG. 2G depicts an isometric view of the exemplary control panel displaying a pattern to be drawn on the surface of a work object, with the plurality of arm segments of the robotic arm assembly in a third position according to example embodiments of this disclosure;

FIG. 2H depicts an isometric view of the exemplary control panel and the plurality of arm segments of the robotic arm assembly in a fourth position according to example embodiments of this disclosure;

FIG. 2I depicts an isometric view of the exemplary control panel and the plurality of arm segments of the robotic arm assembly in a fifth position according to example embodiments of this disclosure

FIG. 3A depicts an isometric view of an exemplary robotic arm assembly drawing a pattern on the surface of a first work object according to example embodiments of this disclosure;

FIG. 3B depicts an isometric view of an exemplary robotic arm assembly drawing a pattern on the surface of a second work object according to example embodiments of this disclosure;

FIG. 4 depicts an isometric view of a terminal arm segment of a plurality of arm segments according to example embodiments of this disclosure;

FIG. 5A depicts a first isometric view of an end effector of a terminal arm segment holding a writing instrument according to example embodiments of this disclosure;

FIG. 5B depicts a second isometric view of an end effector of a terminal arm segment holding a writing instrument according to example embodiments of this disclosure;

FIG. 6 depicts an isometric view of a terminal arm segment of a plurality of arm segments according to example embodiments of this disclosure

FIG. 7 depicts an isometric view of the plurality of arm segments drawing a pattern of the surface of a work object according to example embodiments of this disclosure;

FIG. 8 depicts a top perspective view of plurality of arm segments drawing a pattern of the surface of a work object according to example embodiments of this disclosure

FIG. 9 depicts an isometric view of the plurality of arm segments disposed between a first work object and a second work object according to example embodiments of this disclosure;

FIG. 10A depicts a diagram displaying operation of the robotic arm assembly in use with four work objects on a looped track according to example embodiments of this disclosure;

FIG. 10B depicts a diagram displaying operation of the robotic arm assembly in use with four work objects after a pattern has been drawn on the four work objects according to example embodiments of this disclosure;

FIG. 11A depicts an isometric view of a first actuator of an arm base assembly according to example embodiments of this disclosure;

FIG. 11B depicts a second actuator and a first arm base component of the arm base assembly according to example embodiments of this disclosure;

FIG. 11C depicts a third actuator and a second arm base component of the arm base assembly according to example embodiments of this disclosure;

FIG. 11D depicts a fourth actuator disposed between a first arm segment and a second arm segment according to example embodiments of this disclosure;

FIG. 11E depicts a fifth actuator disposed between the second arm segment and a terminal arm segment according to example embodiments of this disclosure;

FIG. 11F depicts a detachable end effector that is reversibly couplable to the terminal arm segment according to example embodiments of this disclosure;

FIG. 12 depicts a block diagram of an encoder and associated step and direction motor controlled by at least one processor according to example embodiments of this disclosure;

FIG. 13A depicts an isometric view of a curved surface of a work object that a pattern may be drawn on according to example embodiments of this disclosure;

FIG. 13B depicts an isometric view of an I-beam that a pattern may be drawn on according to example embodiments of this disclosure;

FIG. 14 depicts an exemplary writing instrument utilized in drawing a pattern on the surface of a work object according to example embodiments of this disclosure; and

FIG. 15 depicts a method of use of a robotic arm assembly according to example embodiments of this disclosure.

### DETAILED DESCRIPTION

Before explaining various embodiments of the inventive concepts disclosed herein in detail, it is to be understood that the inventive concepts are not limited in their application to the arrangement of the components or steps or methodologies set forth in the following description or illustrated in the drawings. In the following detailed description of embodiments of the instant inventive concepts, numerous specific details are set forth in order to provide a more thorough understanding of the inventive concepts. However, it will be apparent to one of ordinary skill in the art having the benefit of the instant disclosure that the inventive concepts disclosed herein may be practiced without these specific details. In other instances, well-known features may not be described in detail to avoid unnecessarily complicating the instant disclosure. The inventive concepts disclosed herein are capable of other embodiments or of being practiced or carried out in various ways. Also, it is to be understood that the phraseology and terminology employed herein is for the purpose of description and should not be regarded as limiting.

As used herein a letter following a reference numeral is intended to reference an embodiment of a feature or element that may be similar, but not necessarily identical, to a previously described element or feature bearing the same reference numeral (e.g., 1, 1a, 1b). Such shorthand notations are used for purposes of convenience only, and should not be construed to limit the inventive concepts disclosed herein in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” are employed to describe elements and components of embodiments of the instant inventive concepts. This is done merely for convenience and to give a general sense of the inventive concepts, and “a” and “an” are intended to include one or at least one and the singular also includes the plural unless it is obvious that it is meant otherwise.

Also, while various components may be depicted as being connected directly, direct connection is not a requirement. Components may be in data communication with intervening components that are not illustrated or described.

Finally, as used herein any reference to “one embodiment,” or “some embodiments” means that a particular element, feature, structure, or characteristic described in connection with the embodiment is included in at least one embodiment of the inventive concepts disclosed herein. The appearances of the phrase “in at least one embodiment” in the specification does not necessarily refer to the same embodiment. Embodiments of the inventive concepts disclosed may include one or more of the features expressly described or inherently present herein, or any combination or sub-combination of two or more such features.

Broadly, embodiments of the inventive concepts disclosed herein are directed a system for moving an end effector relative to a work surface to draw layouts. The system includes arm segment moveably connected to each other, and a base segment that travels along a rail element. A plurality of actuators control the relative movement of the arm segments, base segment, and end effector to produce a collective, continuous, synchronous movement of the end effector. The actuators may comprise step and direction motors. The system receives a dataset corresponding to the layout to be drawn, and converts the dataset to a series of joint angles for each actuator. Step and direction motors obviate the need for limit switches to set boundaries for the robot arm. The end effector includes a floating marker holding element to allow a marker in the end effector to maintain contact with the work surface without applying excessive force to the marker tip.

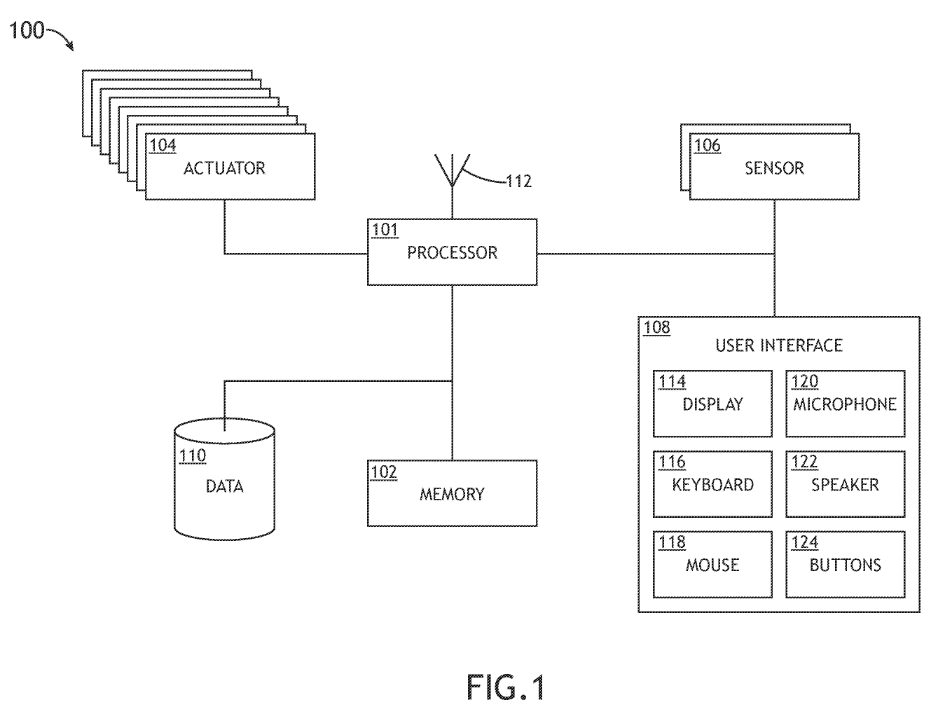

Referring now to FIG. 1, a block diagram of a system 100 for controlling a robotic arm assembly is depicted. The system includes at least one processor 101 and a memory 102 in data communication with the at least one processor 101 for storing non-transitory processor executable code. The processor 101 is in data communication with a plurality of actuators 104; each of the plurality of actuators 104 is disposed and configured to affect the movement of some portion of the robot arm as more fully described herein.

In at least one embodiment, one, more than one, or all of the plurality of actuators 104 may comprise step and direction motors. Step and direction motors are absolute coded motors that may obviate the need for limit switches. Where some or all of the plurality of actuators 104 are step and direction motors, the processor 101 may receive a dataset defining a pattern, image, set of lines, or the like to apply to a work surface. The dataset may be embodied in a data file such (for example: a G-Code file), a data stream received from a separate system, or the like. The processor 101 may convert the dataset into sets of joint angles suitable for step and direction motors. For example, where the dataset defines a series of linear commands, the processor 101 may convert two linear commands into three separate joint angle movements, each corresponding to an actuator in the plurality of actuators 104 to produce a continuous, collective movement of the robot arm. In at least one embodiment, the processor 101 may convert linear commands joint angle movements every millisecond. In at least one embodiment, the processor 101 may receive continuous feedback from the step and direction motors so that the corresponding joint position is known to the processor 101 in real-time.

In at least one embodiment, the system may include a data storage element 110 in data communication with the processor 101 for storing datasets defining a desired movement of the robot arm. Furthermore, the data storage element 110 may store certain configuration information. For example, the processor 101 may define or receive boundaries to limit the movement of the robot arm to prevent damage or injury. In one embodiment, such boundaries may be defined by limit switches. Alternatively, the boundaries may be defined by absolute ranges of movement for each of the plurality of actuators 104 where the plurality of actuators 104 comprise step and direction motors.

In at least one embodiment, the system may include one or more sensors 106 disposed on some portion of the robot arm, or in the environment of the robot arm, and in data communication with the processor 101. For example, vision-based sensors 106 may be disposed proximal to an end effector for identifying a symbol on the work surface indicating an origin point. Alternatively, or in addition, a sensor 106 may be disposed to identify a reference surface on the work surface such that the processor 101 may determine joint angles or actuator movements with respect to the reference surface. For example, a work surface may not be perfectly situated to engage the end effector during normal operation. The reference surface may provide an adjustment factor for the G-Code, linear commands, joint angles, or the like. Such sensors 106 may include sonic sensors, laser range finders, lidar, or the like.

Furthermore, the system may include sensors 106 in data communication with the processor 101 that are disposed in the environment. Such sensors 106 may define a safety zone wherein crossing or violating a safety zone boundary causes the processor 101 to place the robot arm in a safe configuration. In such an embodiment, the processor 101 may define or receive a safe configuration wherein the robot arm is moved to be unobstructive. Where the plurality of actuators 104 comprise step and direction motors, the safe configuration may be defined by sets of joint angles for the plurality of actuators 104.

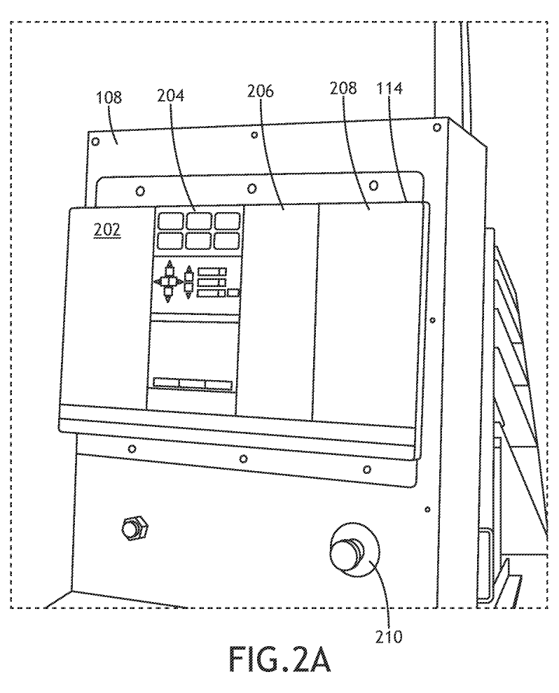

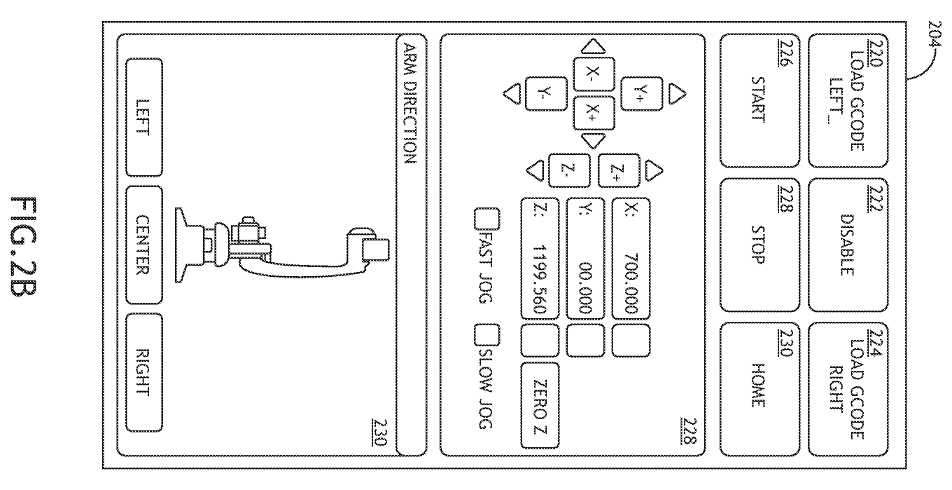

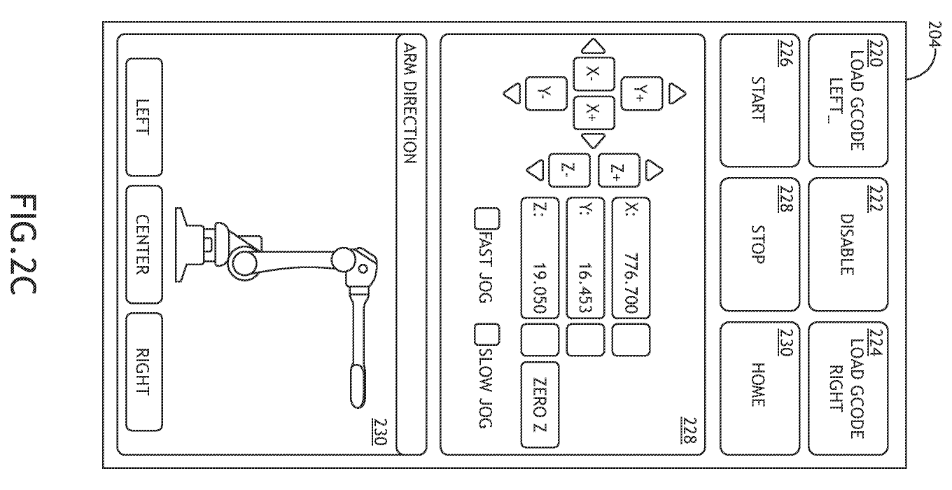

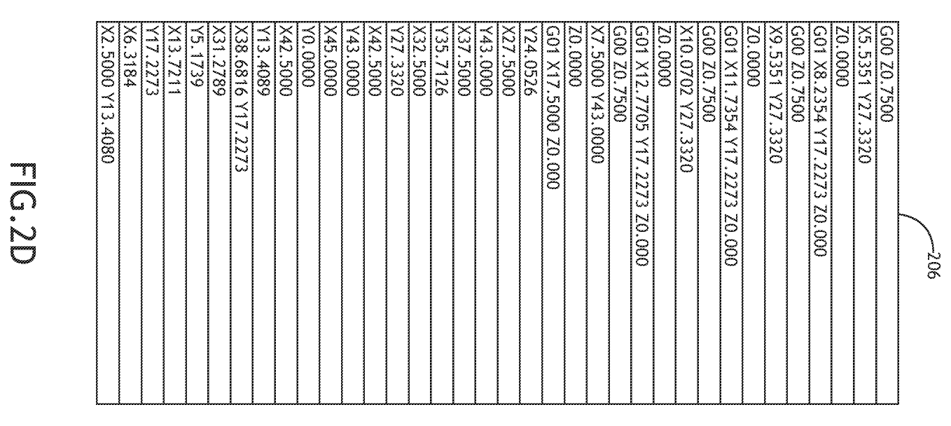

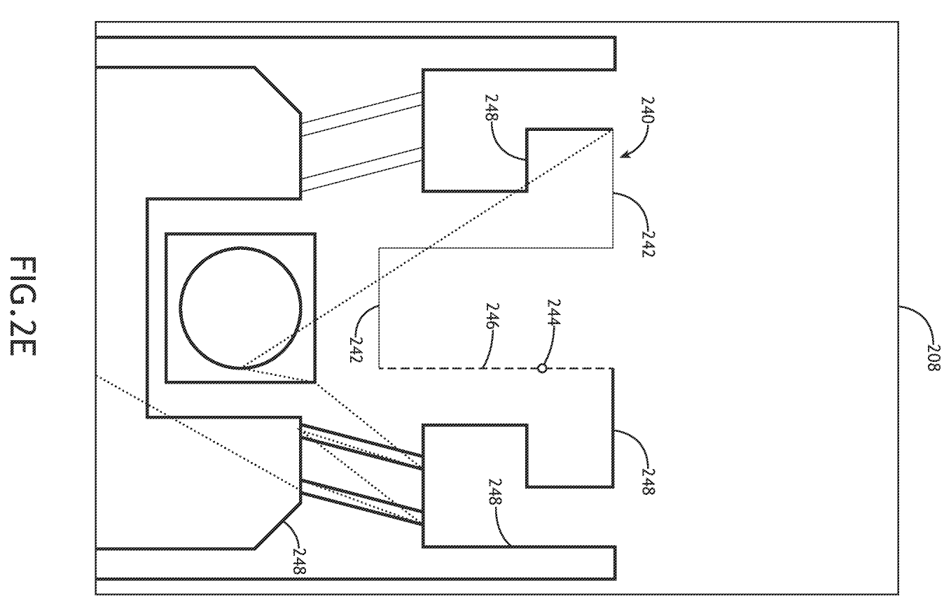

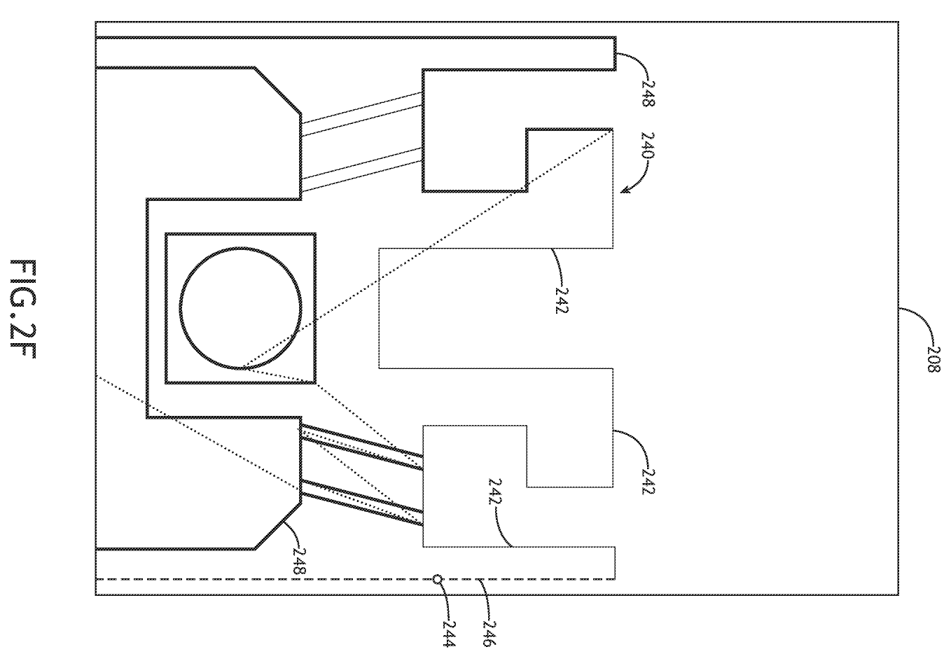

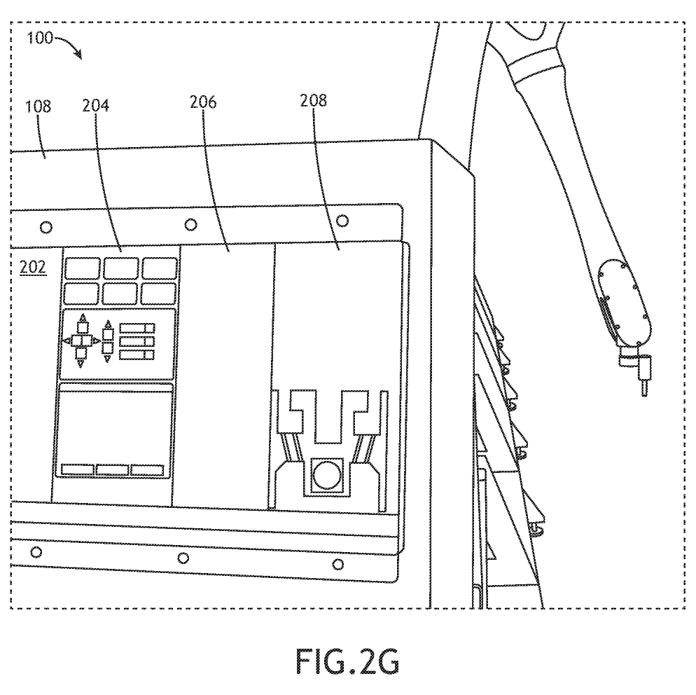

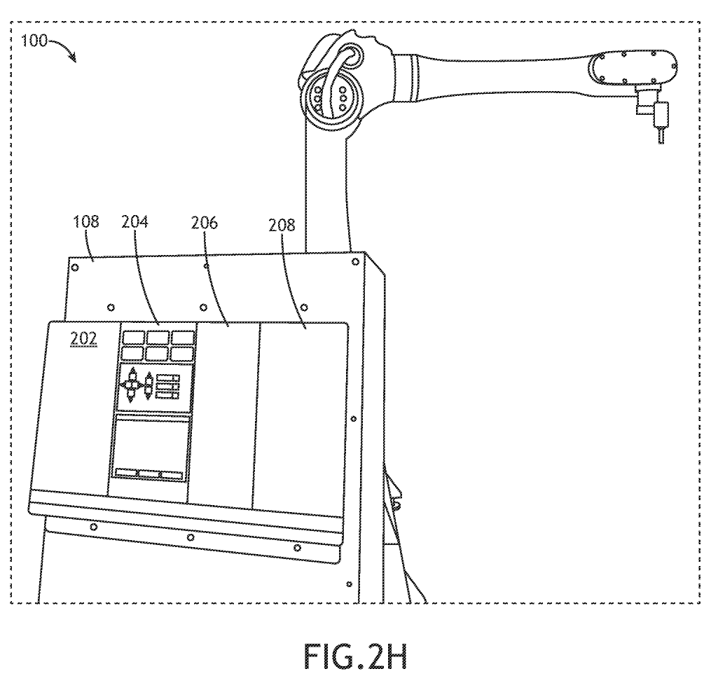

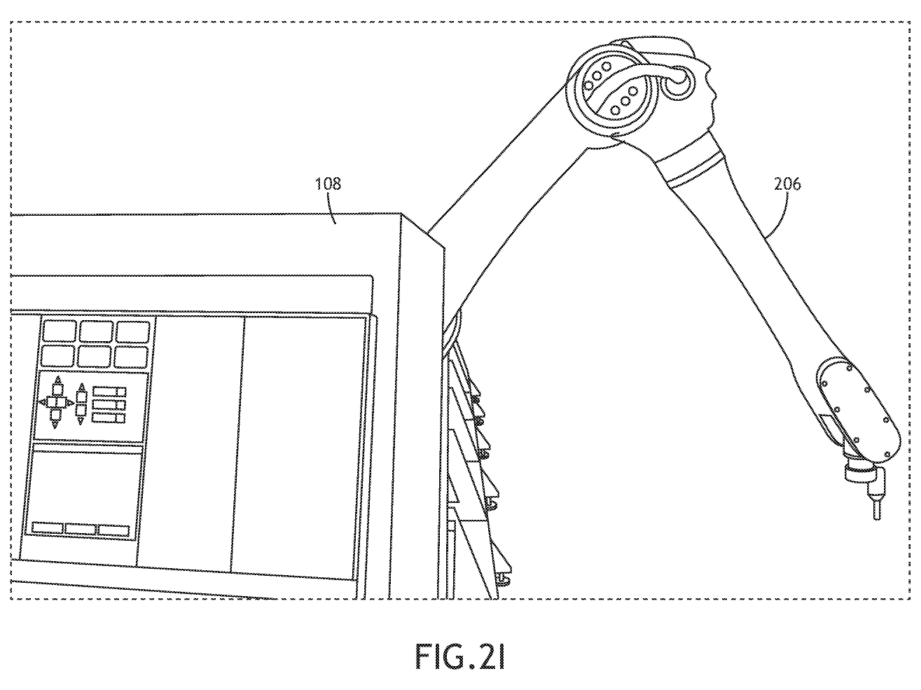

In embodiments, the system 100 further comprises a user interface 108, adapted for receiving user inputted commands for controlling aspects of the robotic arm assembly. In embodiments, the user interface 108 comprises a display 114, a keyboard, 116, a mouse 118, a microphone 120, a speaker 122, and/or buttons 124, or any combination thereof. Specific embodiments of the user interface 108 are discussed in reference to FIGS. 2A-I.

In at least one embodiment, the system may include a data communication element 112 such as a physical data link or wireless datalink in data communication with the processor 101. The processor 101 may thereby receive data, including files defining the movement of the robot arm, and send data, such as status information of a current process.

Referring now to FIGS. 2A-I, an exemplary embodiment of the user interface 108, with respect to (a) an exemplary graphical user interface (GUI) images displayed by a display 114 of the user interface 108, (b) an exemplary design, and (c) an exemplary sequence of user interactions with the user interface 108, is shown.

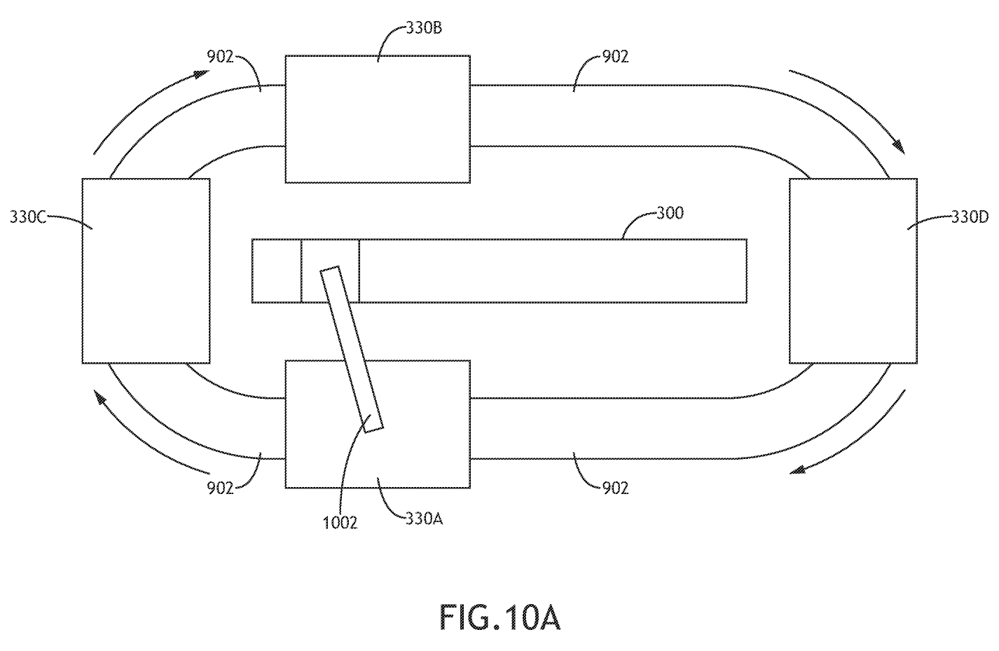

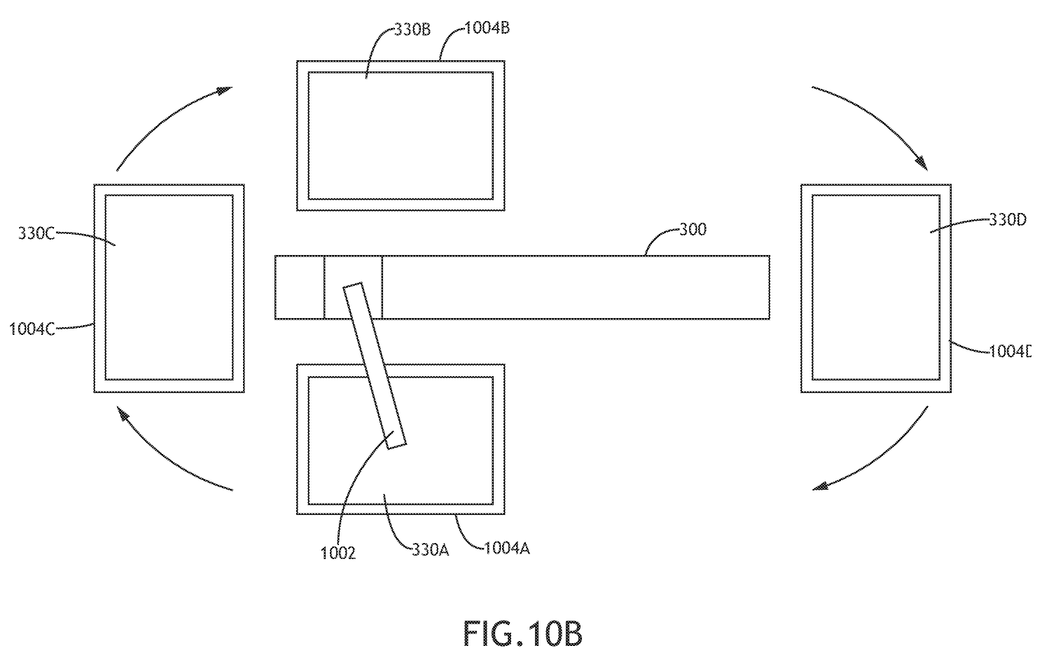

Referring now to FIG. 2A, an exemplary embodiment of the user interface 108 is shown. The display 114 (e.g., a touch-screen display or non-touchscreen display) may display images (e.g., a GUI image having at least one display section (e.g., 202, 204, 206, 208)). For example, the display 114 may display GUI images having first, second, third, and fourth display sections 202, 204, 206, 208. In some embodiments, the user interface 108 may include an emergency stop 210 to stop operation of the robotic arm assembly e.g., 1002 as shown in FIGS. 10A and 10B).

Referring now to FIG. 2B, an exemplary embodiment associated with the second display section 204 is shown. For example, the second display section 204 may include at least one GUI button (e.g., 220, 222, 224, 226, 228, 230) such that a user is able to interact with and input instructions to control any operations of the system 100. For example, the user may interact with the at least one GUI button (e.g., 220 and/or 224) to load a design file, a design, and/or commands (e.g., GCode commands) associated with a design to one of a left side or right side of the structure (e.g., 300). For example, the user may interact with the at least one GUI button (e.g., 222) to disable the robotic arm assembly (e.g., 1002). For example, the user may interact with the at least one GUI button (e.g., 226) to cause at least one processor 101 to output instructions or signals to cause the robotic arm assembly (e.g., 1002) to start drawing a pattern associated with the design on the work object. Likewise, the user may interact with the at least one GUI button (e.g., 228) to cause at least one processor 101 to output instructions or signals to cause the robotic arm assembly (e.g., 1002) to stop drawing a pattern associated with the design on the work object. For example, the user may interact with the at least one GUI button (e.g., 230) to cause at least one processor 101 to output instructions or signals to move the robotic arm assembly (e.g., 1002) to a home position. Additionally, the second display section 204 may include sub-sections 228, 230. For example, a first sub-section may display a current position of the tip of the writing instrument with X, Y, and Z coordinates. Additionally, second sub-section 230 may depict an arm assembly image (e.g., depicting a current orientation and position of the robotic arm assembly) and one or more GUI buttons, to switch from drawing on one of the left or right side of the structure (e.g., 300).

FIG. 2C shows a view of the second display section 204 at a different time when the robotic arm assembly has been moved into a different position and orientation, after having been instructed to start drawing the pattern on the right side.

Referring now to FIG. D, an exemplary embodiment associated with the third display section 206 is shown. For example, the third display section 206 may show information associated with sequential information and/or operations associated with a design path associated with the design and/or with a conversion of the design path to angular adjustments to control the plurality of actuators 104.

Referring now to FIGS. 2E-F, an exemplary embodiment associated with the fourth display section 208 is shown as displaying a progress along a loaded design 240 at two different times. With respect to FIG. 2F, the design 240 may be depicted as including segments 242 (e.g., already drawn segments), 248 (e.g., unstarted segments), 246 (e.g., partially drawn segment(s)), as well as position indicator 244 associated with a position of the tip of the writing utensil relative to the pattern and/or the design.

Referring now to FIGS. 2G, 2H, and 2I, an exemplary embodiment of the user interface 108 at three different times is shown.

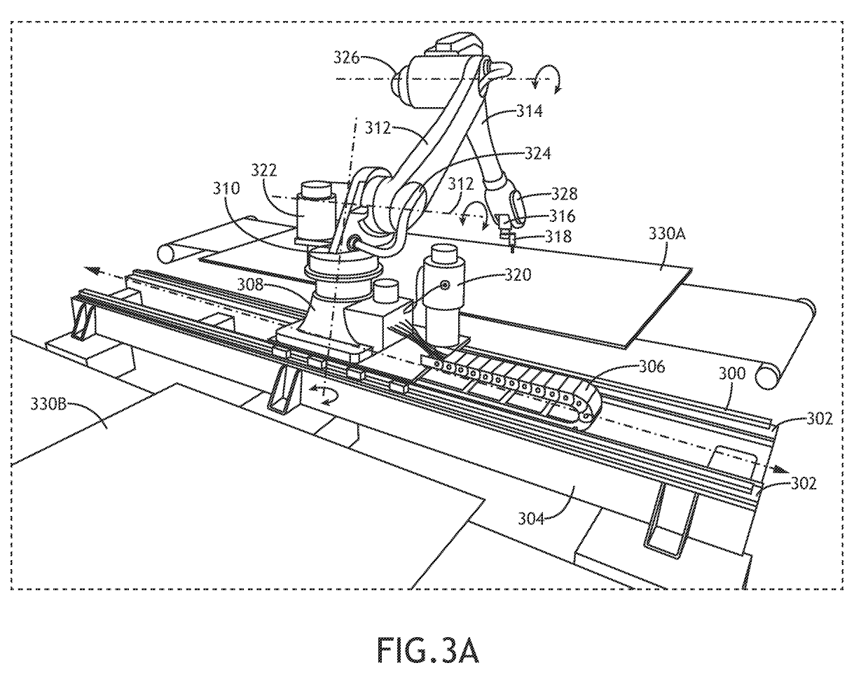

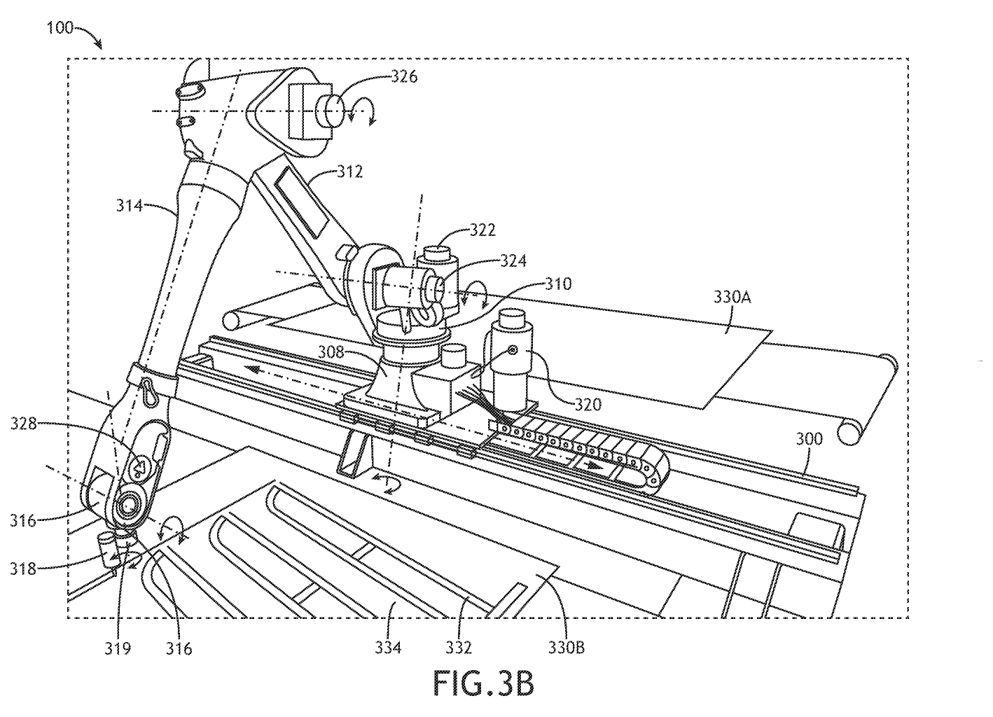

Referring now to FIGS. 3A-B, embodiments of the robotic arm assembly (e.g., 1002 as shown in FIGS. 10A and 10B; e.g., which may include first arm segment 312, a second arm segment 314, a terminal arm segment 316, a first arm base component 308 , a second arm base component 310, actuators 320, 322, 324, 326, 328, and an end effector 318) are depicted. FIG. 3A depicts an isometric, environmental view of an exemplary robotic arm assembly drawing a pattern on the surface of a first work object. FIG. 3B depicts an isometric view of an exemplary robotic arm assembly drawing a pattern on the surface of a second work object.

As generally depicted, the robotic arm assembly is positioned along a structure 300 (the structure 300 comprising two rails 302 set atop a structure base 304). Travel along the structure 300 can be accomplished through a flexible cable guide 306, providing for translational movement along the length of structure 300. As further depicted, the robotic arm assembly comprises an arm base assembly comprising a first arm base component 308 and a second arm base component 310 positioned at a bottom portion of the robotic arm assembly and configured for travel along the structure 300.

In embodiments, the robotic arm assembly comprises a first arm segment 312, a second arm segment 314, a terminal arm segment 316, and an end effector 318. Furthermore, the robotic arm assembly further comprises a plurality of actuators, each disposed to effect and control the movement of certain portions of the robotic arm assembly. In the depicted embodiment, for example, the robotic arm assembly 1002 comprises a plurality of actuators, including, for example: a first actuator 320, a second actuator 322, a third actuator 324, a fourth actuator 326, and a fifth actuator 328. In embodiments, each of actuator of the plurality of actuators may be individually or collectively configured to at least: move the arm of the base assembly along the structure 300; rotate the second arm base component 310 relative to the first arm base component 308; move the first arm segment 312 relative to the second arm base component 310 about a second axis passing through a joint; move the second arm segment 314 about a third axis passing through a first arm segment joint; and/or move the terminal arm segment 316 about a fourth axis passing through a terminal arm segment joint. In embodiments, an optional and or further sixth actuator 319 may also be implemented. In embodiments, the optional sixth actuator may be configured to rotate the end effector 318 about a fifth axis.

As further depicted in FIGS. 3A-3B, the robotic arm assembly (e.g., robotic arm assembly 1002 as depicted in FIG. 10A-B) when positioned on structure 300, may be set between a first work object 330A and a second work object 330B. In embodiments, each of the first work object 330 and second work object 330B may be objects selected to have a pattern imprinted or imparted by the robotic arm assembly, as described herein. For example, each of the first work object 330A and second work object 330B may be any object, such as a work surface, I-beam, manufactured or 3-D printed objects, paneling, steel beams, or other surfaces that a pattern can be imparted onto. In embodiments, and as described below, the robotic arm assembly can be adapted for translational and rotational movement to impart patterns on the first work object 330A and the second work object 330B. For example, FIG. 3B depicts an exemplary pattern 332 being imparted on the work surface 334 of the second work object 330B.

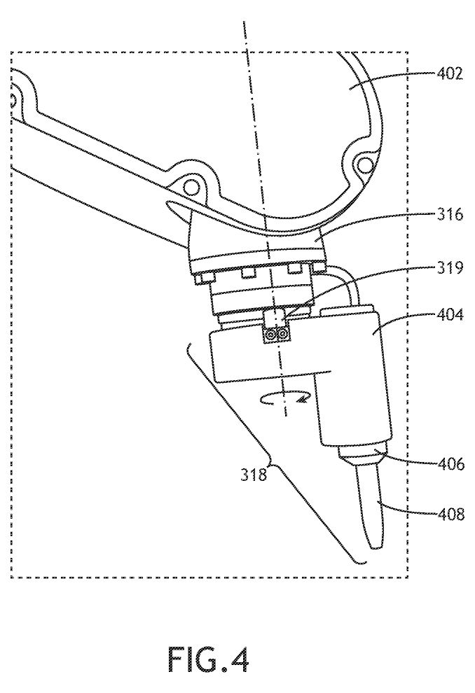

FIG. 4 depicts an exemplary, isometric view of the terminal arm segment 316 and the end effector 318. In embodiments, the end effector 318 connected to the terminal arm segment 316 may be adapted and configured for retaining a writing instrument. Furthermore, as depicted in FIG. 4, one or more of the arm segments (e.g., first arm segment 312, second arm segment 314, etc.) may comprise a cover 402, with protects the internal wiring and parts of the robotic arm assembly.

As depicted, the terminal arm segment 316 and the end effector 318 may be reversibly and detachably couplable. Furthermore, in embodiments, the end effector further comprises an end effector structure 404, and an instrument receptacle 406. In embodiments, the instrument receptacle 406 is adapted and configured for receiving and holding a writing instrument 408, which is used to impart a pattern on another object, including for example, work object 330A and/or 330B as identified above. In embodiments, the writing instrument 408 may be a marker, but any writing instrument or device capable of imparting a pattern may be utilized. In embodiments, the optional sixth actuator 319, as described above, may be disposed on the effector structure 404.

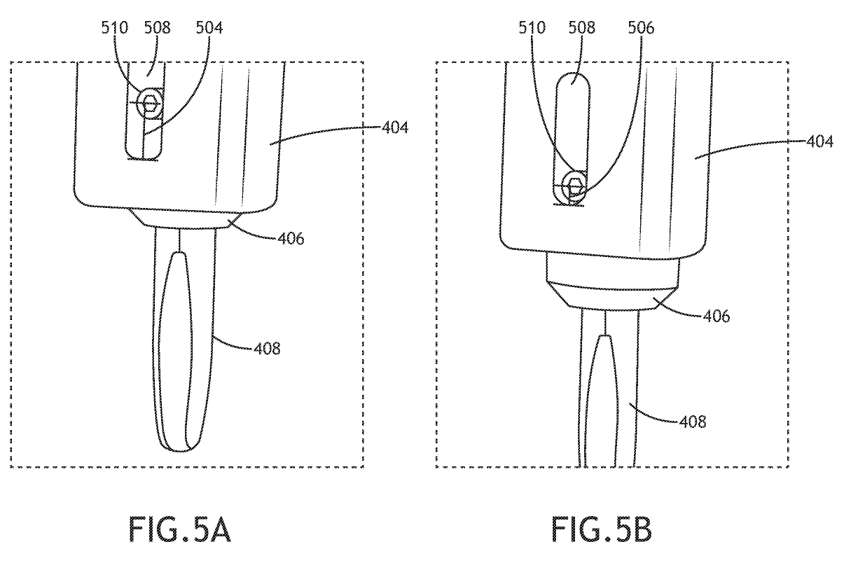

Referring to FIG. 5A-5B, partial, detail views of the end effector 318 according to an exemplary embodiment are shown. In at least one embodiment, the instrument receptacle 406 (holding writing instrument 408) is configured to translate linearly (up and down) within the effector structure 404. The range of translation, depicted by a first distance 504 in FIG. 5A and a second distance 506 in FIG. 5B, may be constrained by a channel 508 defined by the effector structure 404 and a pin 510 connected to the instrument receptacle 406 and disposed to travel within the channel 508.

It may be appreciated that work surfaces may not be entirely flat. Furthermore, even when drawing on an entirely flat surface, the robotic arm assembly may apply excessive pressure to the writing instrument 408, wearing out the marker tip prematurely. Accordingly, embodiments are contemplated wherein the end effector 318 allows the writing instrument 408 a degree of travel may keep the writing instrument 408 in continuous contact with the work surface, and also prevent excessive load at the tip of the writing instrument 408. In embodiments, the effector structure 404 holding may travel entirely via gravity. Alternatively, the end effector 318 may include some biasing element such as a spring or separate weight to generally bias the writing instrument 408 toward the work surface.

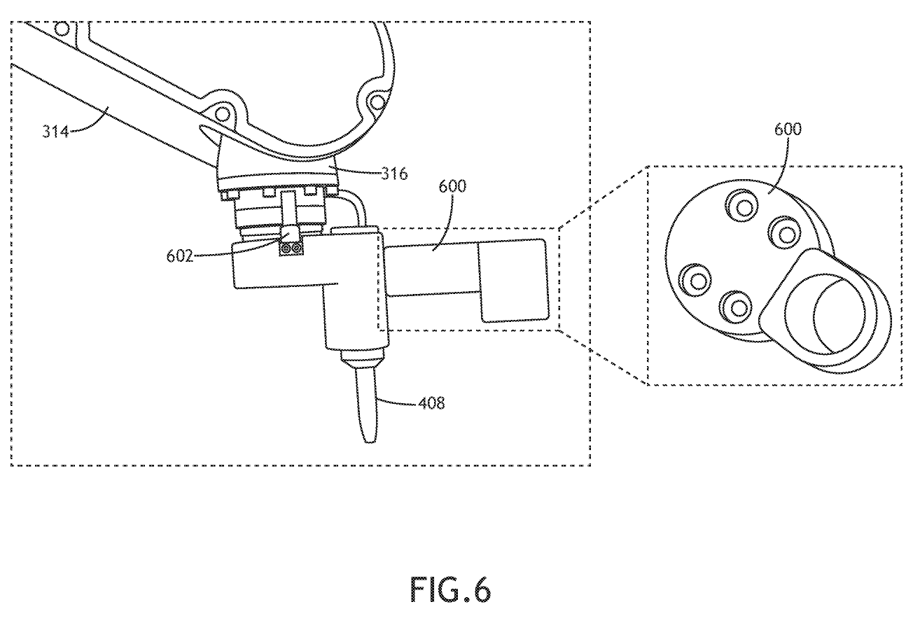

Referring to FIG. 6, an additional isometric view of the terminal arm segment 316 is depicted. In embodiments, the end effector 318 may be detachable from the terminal arm segment 316. For example, the end effector 318 may include a magnet or other features that allow the end effector to be removed and replaced quickly. Furthermore, in embodiments, the operation of the robotic arm assembly utilizes a control system that receives and processes the location and orientation of the end effector 318. Therefore, the end effector 600, or terminal arm segment 316, or both, may include alignment features 602 that ensure the end effector 600 may only be connected in the proper orientation.

In at least one embodiment, the terminal arm segment 316 and/or the end effector 318 may include a power take off or power pass through to facilitate powered end effectors 600. Furthermore, powered end effectors 600 may be configured to fail in the event excessive force in applied. Failure may include detaching or physical failure of the materials.

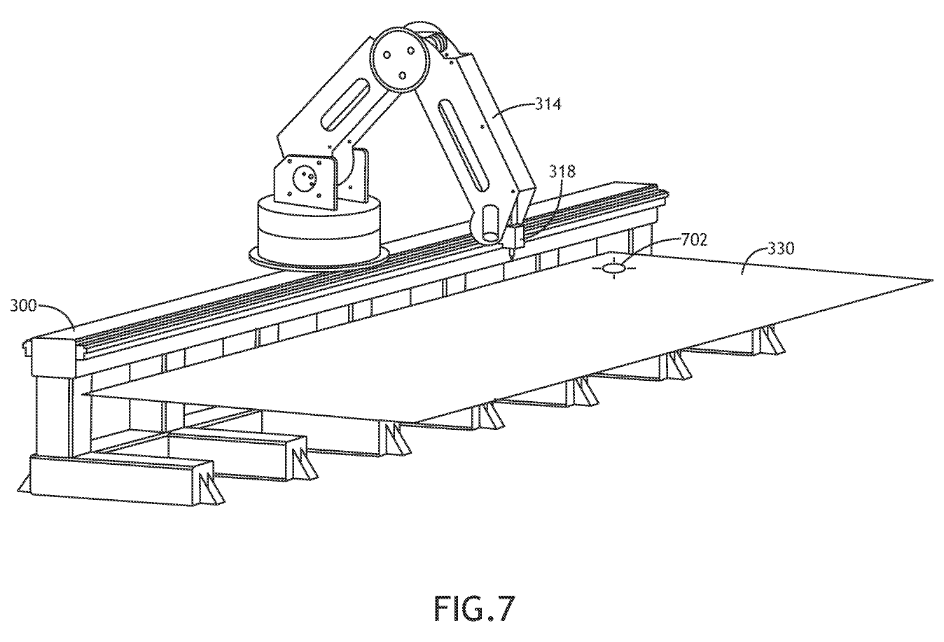

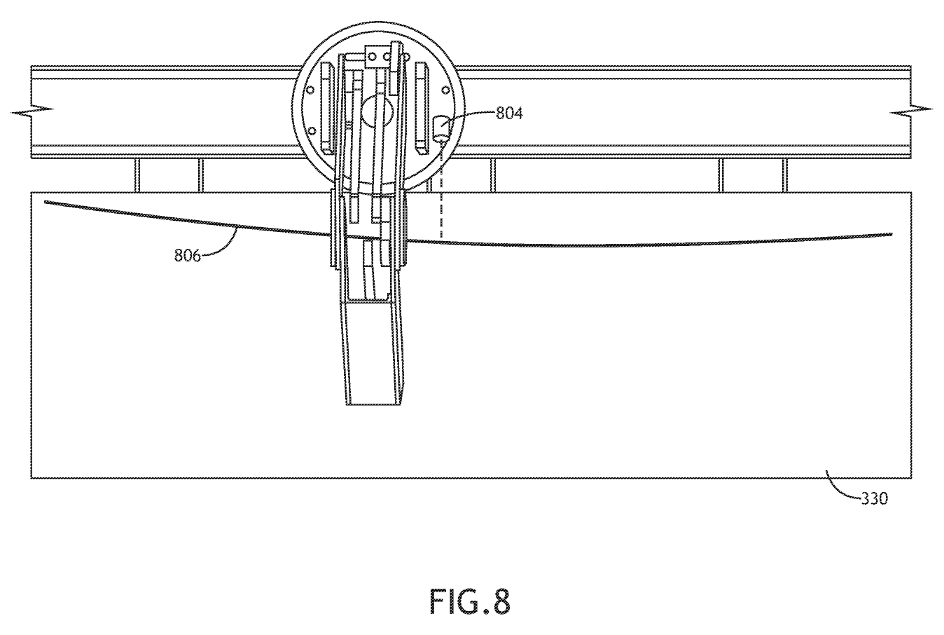

Referring to FIG. 7, an isometric view depicting the robotic arm assembly drawing a pattern of the surface of a work object is shown. As depicted, the robotic arm assembly can utilize one or more location indicators 702 located on a work object 330. The one or more location indicators 702 may be visual indicators or signal-based tags that define an origin point or some other reference point to calibrate the location of the end effector 318 during use. Accordingly, when traveling along structure 300, the robotic arm assembly can utilize the one or more location indicators 702 when moving into position, including for example, moving the second arm segment 314 into position.

Referring to FIG. 8, a top perspective view of the robotic arm assembly according to an exemplary embodiment is shown. In at least one embodiment, the robotic arm assembly may include may include a sensor 804 such as a vision sensor, distance sensor, sonic sensor, lidar, or the like, disposed and configure to identify a reference surface 806 on the work object 330. The reference surface 806 may define the position and orientation of the work object 330 such that the control system (processor and actuators) may adjust the location of the end effector 318 based on the location of the reference surface 806. For example, if the reference surface 806 is at some angle to the set of rails 302 that the robotic arm assembly is moving along, the processor may adjust the joint angles of the actuators in real-time to maintain the desired drawing on the work object 330.

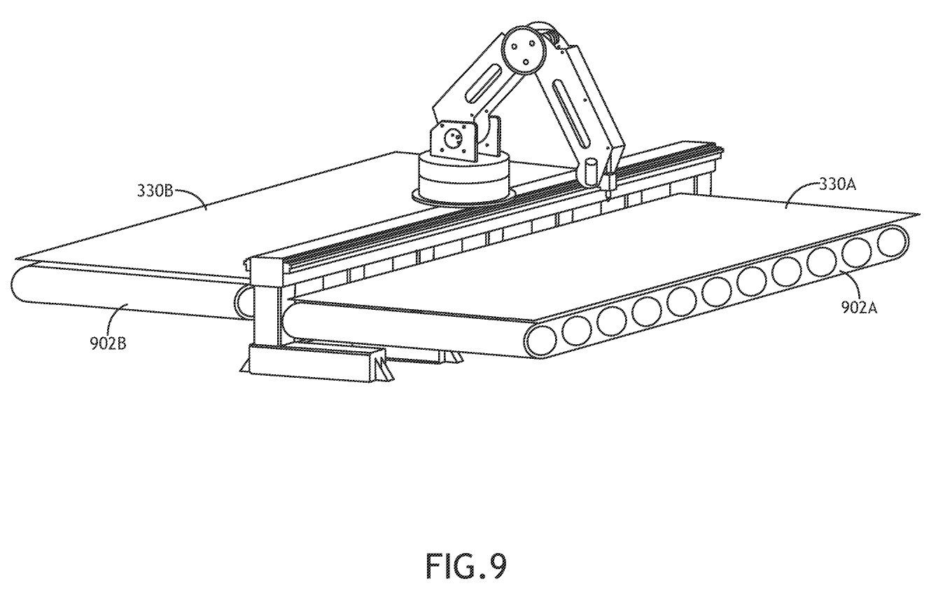

Referring to FIG. 9, a perspective, environmental view of the robotic arm assembly (e.g., robotic arm assembly 1002) according to an exemplary embodiment is depicted. In embodiments, the robotic arm assembly may include one or more conveyors 902A, 902B disposed to move work objects 330A, 330B through a set of boundaries that define the operational range of the robotic arm assembly. Such conveyors 902A, 902B may allow for larger work surfaces than otherwise possible, and allow a continuous train of work surfaces to facilitate the efficient utilize of the robotic arm assembly. In at least one embodiment, the first conveyor 902A is disposed on a first side of a set of rails and the second conveyor 902B is disposed on an opposite side of the set of rails.

It may be appreciated that the robotic arm assembly may rotate to engage work objects 330A, 330B on either side of the set of rails supporting the robotic arm assembly. Furthermore, it may be appreciated that the control system of the robotic arm assembly (processor and actuators) may be configured to operate the conveyors 902A, 902B and thereby move the work objects 330A, 330B as part of the drawing process.

Referring to FIGS. 10A and 10B, a diagram displaying an exemplary operation of the robotic arm assembly in use with four work objects on a looped track is depicted. As depicted, the robotic arm assembly 1002 may be positioned along the structure 300 in the manner described above with respect to FIGS. 3A-B. In operation, and as depicted, multiple work objects may be rotated about the robotic arm assembly 1002 and the structure 300 during operation. In the depicted embodiment in FIG. 10A, work objects 330A, 330B, 330C, and 330D may be translated along a looped track 902, such as a looped, ring-shaped track), thereby rotating about the robotic arm assembly. For example, the looped track 902 may be deployed as a track system which may be supported from, attached to, and/or suspended from the ground, walls, overhang, or ceiling, a rail system, or conveyer system. Furthermore, it should be appreciated that while the illustrated embodiment depicts a clockwise rotation, the work objects 330A, 330B, 330C, and 330D may be rotated counterclockwise.

In further embodiments, the looped track 902 may be replaced with one or more movable, positionable support structures, including, for example, racks, shelves, carts, or tables or similar objects having wheels, (e.g., wheeled rack, wheeled shelf, wheeled cart, or wheeled table) that allow the work objects to be moved around the robotic arm assembly 1002 without the use of a guided track. For example, each of work objects 330A, 330B, 330C, and 330D may be paired with positionable tables 1004A, 1004B, 1004C, and 1004D respectively. For example, in embodiments, each of the positionable tables 1004A, 1004B, 1004C, and 1004D may be a wheeled table that the work object is placed on top of for movement about the robotic arm assembly 1002.

In embodiments, including for example the embodiments depicted in FIGS. 10A-B, an assembly line system or assembly loop system may be integrated, wherein the system is adapted for moving at least three work objects (e.g., work objects 330A, 330B, 330C, and 330D)into any of at least three work spaces (e.g., first side end effector work space, second side end effector workspace, at least one assembly (or generic work space, at least one work object receive workspace, and/or at lest one completed work object workspace) along the assembly line system or assembly loop system.

Furthermore, while FIG. 10A shows an exemplary embodiment including a looped track, in other embodiments, the track 902 may be implemented as a non-looped track(s), a U-shaped or L-shaped track, or as multiple tracks (e.g., which may include a linear track(s) and/or non-linear track(s); e.g., some or all of which may be parallel, perpendicular, or otherwise arranged with respect to another of the multiple tracks).

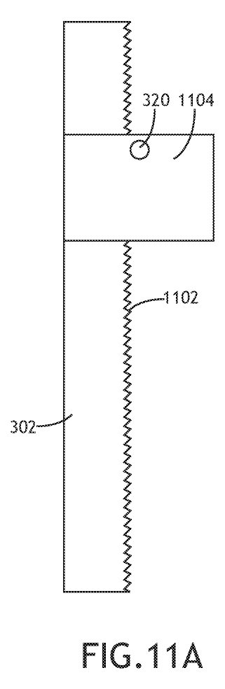

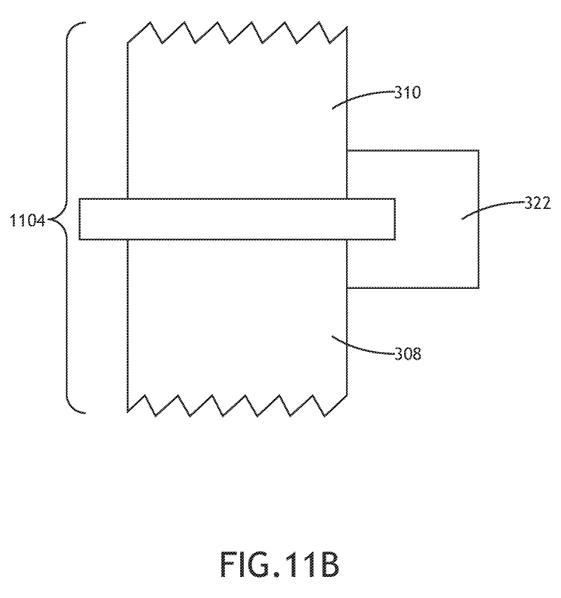

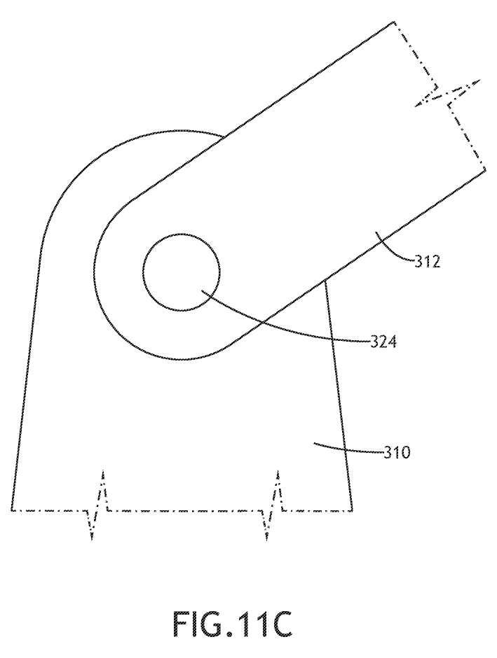

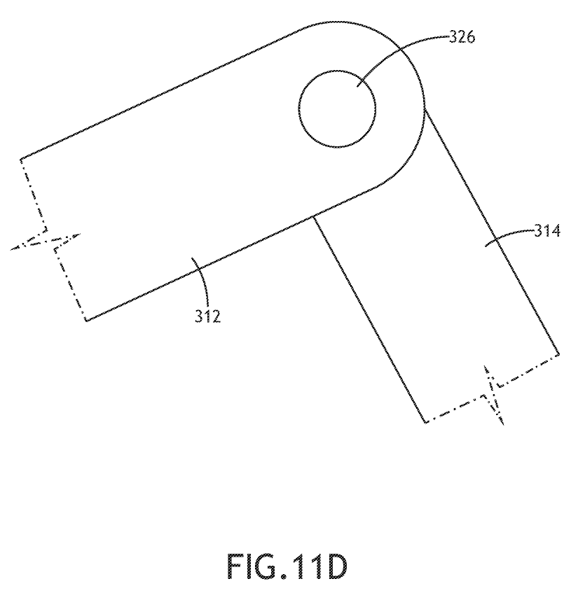

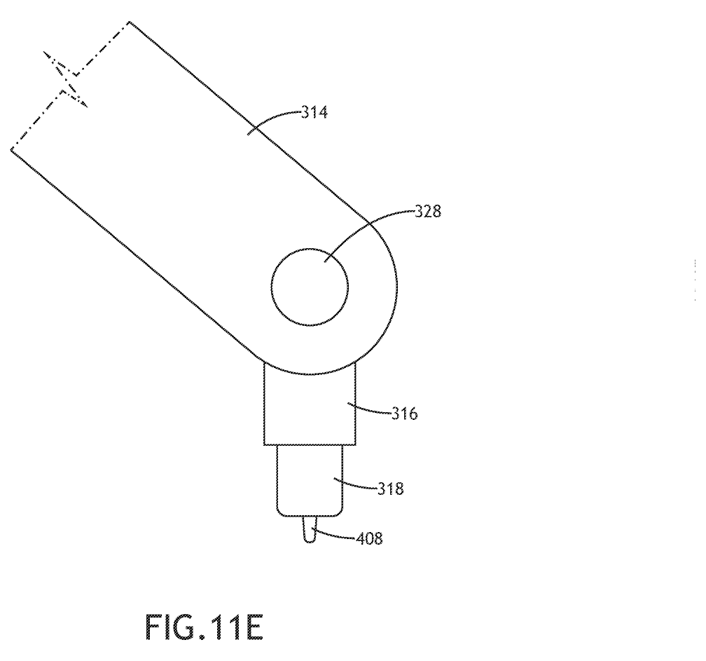

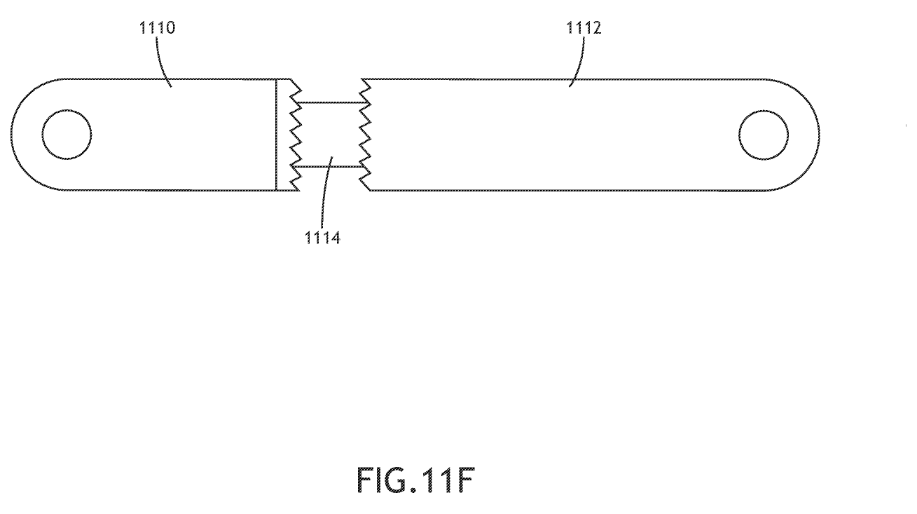

Referring now to FIGS. 11A-11F, exemplary isometric and partial views of actuators of the plurality of actuators are depicted. As depicted in FIG. 11A, the first actuator 320 is shown. In embodiments, the first actuator 320 is positioned on at least one of the rails 302. As further depicted, embodiments of rail 302 further comprises a plurality of teeth 1102 for engaging with the arm base assembly 1104.

As depicted in FIG. 11B, the second actuator 322 is shown. In embodiments, the second actuator 322 is positioned between the first arm base component 308 and the second arm base component 310 of the arm base assembly 1104.

As depicted in FIG. 11C, the third actuator 324 is shown. In embodiments, the third actuator 324 is located approximate to and between the second arm base component 310 and the first arm segment 312.

As depicted in FIG. 11D, the fourth actuator 326 is shown. In embodiments, the fourth actuator 326 is located approximate to and between the first arm segment 312 and the second arm segment 314.

As depicted in FIG. 11E, the fifth actuator 328 is shown. In embodiments, the fifth actuator is located approximate to the distal end of the second arm segment 314 and between the second arm segment 314 and the terminal arm segment 316. Furthermore, the position of the fifth actuator 328 relative to the end effector 318 and the writing instrument 408 is also depicted.

As depicted in FIG. 11F, the sixth actuator 1114 is depicted. In embodiments, an optional and/or additional sixth actuator 1114 may be selectively positioned between two sub-sects of any of the arm segments of the plurality of arm segments. For example, any of the arm segments may comprise a first subsegment 1110 and a second subsegment 1112, wherein the first subsegment 1110 is connected, via the sixth actuator 1114 acting as a subsegment joint, to the second subsegment 1112. In embodiments, the sixth actuator allows the second subsegment 1112 to move with at least one degree of freedom relative to the first subsegment 1110, wherein the plurality of actuators (e.g., actuators 320, 322, 324, 326, and/or 328) is further collectively configured to rotate the second subsegment 1112 relative to the first subsegment 1110 about a sixth axis, the sixth axis being colinear with the second subsegment 1112.

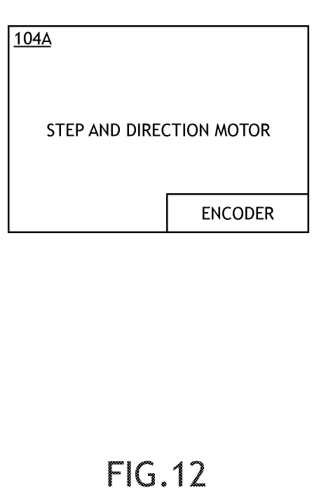

Referring to FIG. 12, a block diagram depicting a step and direction motor 104A is shown. As described above, each of the plurality of actuators 104 may comprise a step and direction motor 104A. In embodiments, the step and direction motor 104A may include an encoder configured for generating encoder signals. In embodiments, the at least one processor 101 is further configured to access or generate design path information associated with at least one design path, wherein each of the at least one design path is located along a modelled or reference surface. Furthermore, collectively the at least one design path matches the design relative to the modelled or reference surface except that the modelled or reference surface does not necessarily have a same position and/or a same orientation as the surface of the work object (e.g., work object 330A, 330B). The at least one processor 101 is further configured to, repeatedly receive over time, from each step and direction motor 104A, encoder signals indicative of a current joint angle of a given joint. The step and direction motor 104A may be associated with a joint between two components driven by said step and direction motor 104A. Furthermore, based at least on the encoder signals and at least one of (a) a known and/or ascertained position of the surface of the work object or (b) a known and/or ascertained orientation of the surface of the work object, the at least one processor 101 may determine, over time, joint angle adjustments associated with each joint, each joint associated with a particular step and direction motor 104A, each joint angle adjustment of one joint angle corresponding to a step and direction for one of step and direction motors 104A; and based at least on the joint angle adjustments over time, output the at least one of the instructions or the signals that cause the plurality of actuators (e.g., actuators 320, 322, 324, 326, and/or 328) to collectively move the tip 1404 of the writing instrument 1402 along the three-dimensional path relative to the position of and the orientation of the work object. Even further, based at least on the joint angle adjustments over time, the at least one processor 101 may further output the at least one of the instructions or the signals that cause the plurality of actuators to collectively move the tip 1404 of the writing instrument 1402 along the three-dimensional path relative to the position of and the orientation of the work object in accordance with the design to draw the pattern 332 on the surface of the work object.

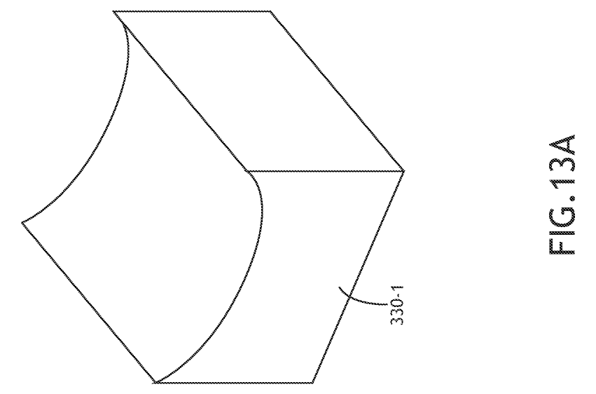

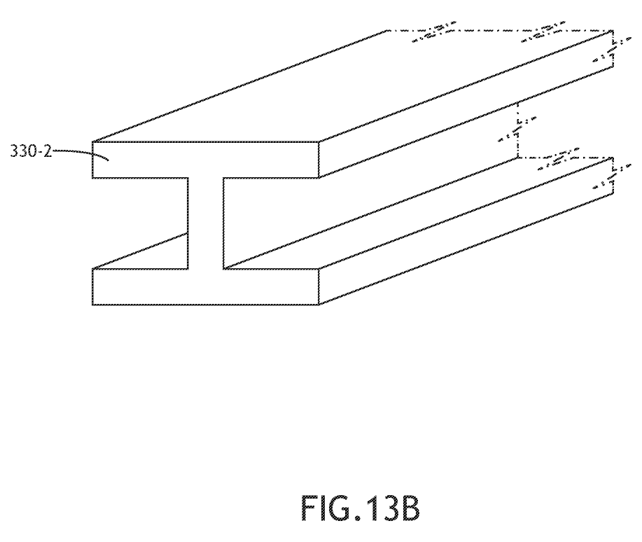

Referring to FIGS. 13A and 13B, exemplary surfaces that the robotic arm assembly 1002 may be utilized with are depicted. As described herein, embodiments are contemplated in which the surface of the work object is not flat or planar, but through translational of the writing instrument 408, a pattern may still be imparted. For example, FIG. 13A depicts a curved surface work object 330-1 that a pattern may be imparted on. Furthermore, FIG. 13B depicts an I-Beam work object 330-2 that a pattern may be imparted on.

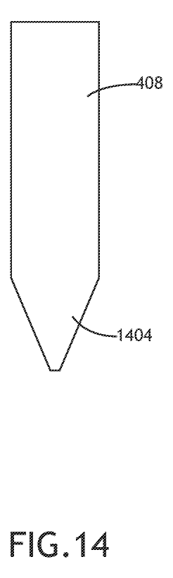

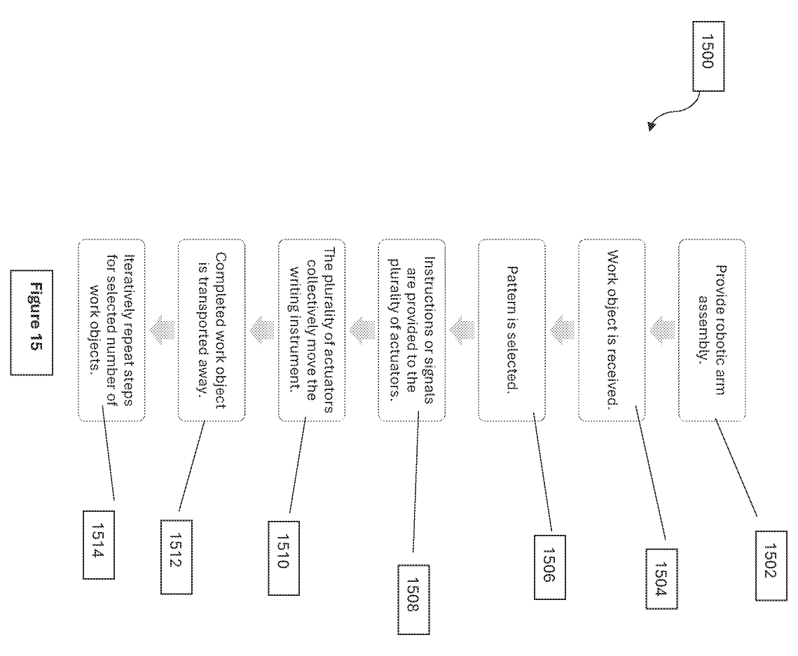

Referring to FIG. 14, an enlarged perspective view of an exemplary writing utensil is depicted. As depicted, the writing instrument 1402 may comprise a tip 1404, which may be utilized when imparting the pattern of a surface.

Referring to FIG. 15, an exemplary flow diagram depicting method 1500 is shown. At step 1502, a robotic arm assembly is provided. In embodiments, the robotic arm assembly comprises: a plurality of arm segments including the first arm segment 312, the second arm segment 314, and the terminal arm segment 316. Furthermore, the each arm segment of the plurality of arm segments is connected, via at least one arm segment joint, to at least one adjacent arm segment of the plurality of arm segments, wherein each of said at least one arm segment joints allows a given arm segment of the plurality of arm segments to move with at least one degree of freedom relative to a given adjacent arm segment that is adjacent the given arm segment, wherein said at least one arm segment joints includes a first arm segment joint and a terminal arm segment joint, wherein the first arm segment joint connects the first arm segment and the second arm segment, wherein the terminal arm segment connects at the terminal arm segment joint. The system further comprises the arm base assembly 1104 including the first arm base component 308 and the second arm base component 310. In this embodiment, the arm base assembly 1104 is configured to travel along the structure 300, wherein the first arm base component 308 is connected, via an arm base joint, to the second arm base component 310, wherein the arm base joint allows the second arm base component 310 to move with at least one degree of freedom relative to the first arm base component 308. Further, the second arm base component 310 is connected, via a joint, to the first arm segment 312, wherein the joint allows the first arm segment 312 to move with at least one degree of freedom relative to the second arm base component 310. The system further comprises the end effector 318 connected to the terminal arm segment 316, with the end effector 318 comprising the writing instrument 1402 having a tip 1404. Even further, the system comprises a plurality of actuators (e.g., actuators 320, 322, 324, 326, and/or 328) configured to: move the arm base assembly 1104 along the structure 300; rotate the second arm base component 310 relative to the first arm base component 308 about a first axis passing through the second arm base component 310 and the first arm base component 308; move the first arm segment 312 relative to the second arm base component 310 about a second axis passing through the joint, wherein the first axis and the second axis are non-parallel; move the second arm segment 314 about a third axis passing through the first arm segment joint; and move the terminal arm segment 316 about a fourth axis passing through the terminal arm segment joint. The system further comprises at least one processor 101 communicatively coupled at least with the plurality of actuators.

At step 1504, a work object (e.g., work object 330A, 330B) is received. In embodiments, the work object may be received and placed into position using a track (e.g., track 902) which places the work object approximate to the robotic arm assembly.

At step 1506, a pattern 332 may be selected. In embodiments, the pattern 332 is selected via the at least one processor 101 accessing data associated with one or more designs.

At step 1508, the at least one processor 101 outputs instructions or signals to the plurality of actuators (e.g., actuators 320, 322, 324, 326, or 328). In embodiments, the instructions or signals sent to the plurality of actuators is associated with the selected pattern 332.

At step 1510, the plurality of actuators (e.g., actuators 320, 322, 324, 326, or 328) collectively move the move the tip 1404 of the writing instrument 1402 along a three-dimensional path relative to a position of and an orientation of a work object such that the tip 1404 of the writing instrument 1402 interacts with the work object in accordance with the design to draw a pattern 332 on a surface of the work object, the pattern 332 corresponding to the design.

At step 1512, upon completion of the pattern 332 being drawn on the surface of the work object, the work object can be transported via track 902 away from the robotic arm assembly.

At step 1514, steps 1504 through 1512 may be iteratively repeated with any number of work objects. During the iterative repeating of the steps, one pattern 332 may be used with multiple work objects, or different patterns may be selected.

In embodiments, the robotic arm assembly 1002 is part of a system comprising: a plurality of arm segments including the first arm segment 312, the second arm segment 314, and the terminal arm segment 316. Furthermore, the each arm segment of the plurality of arm segments is connected, via at least one arm segment joint, to at least one adjacent arm segment of the plurality of arm segments, wherein each of said at least one arm segment joints allows a given arm segment of the plurality of arm segments to move with at least one degree of freedom relative to a given adjacent arm segment that is adjacent the given arm segment, wherein said at least one arm segment joints includes a first arm segment joint and a terminal arm segment joint, wherein the first arm segment joint connects the first arm segment and the second arm segment, wherein the terminal arm segment connects at the terminal arm segment joint. The system further comprises the arm base assembly 1104 including the first arm base component 308 and the second arm base component 310. In this embodiment, the arm base assembly 1104 is configured to travel along the structure 300, wherein the first arm base component 308 is connected, via an arm base joint, to the second arm base component 310, wherein the arm base joint allows the second arm base component 310 to move with at least one degree of freedom relative to the first arm base component 308. Further, the second arm base component 310 is connected, via a joint, to the first arm segment 312, wherein the joint allows the first arm segment 312 to move with at least one degree of freedom relative to the second arm base component 310. The system further comprises the end effector 318 connected to the terminal arm segment 316, with the end effector 318 comprising the writing instrument 1402 having a tip 1404. Even further, the system comprises a plurality of actuators (e.g., actuators 320, 322, 324, 326, and/or 328) configured to: move the arm base assembly 1104 along the structure 300; rotate the second arm base component 310 relative to the first arm base component 308 about a first axis passing through the second arm base component 310 and the first arm base component 308; move the first arm segment 312 relative to the second arm base component 310 about a second axis passing through the joint, wherein the first axis and the second axis are non-parallel; move the second arm segment 314 about a third axis passing through the first arm segment joint; and move the terminal arm segment 316 about a fourth axis passing through the terminal arm segment joint. The system further comprises at least one processor 101 communicatively coupled at least with the plurality of actuators. The at least one processor 101 configured to access data associated with a design (e.g., pattern 332); and output at least one of instructions or signals that cause the plurality of actuators to collectively move the tip 1404 of the writing instrument 1402 along a three-dimensional path relative to a position of and an orientation of a work object ( e.g., work object 330A and/or 330B) such that the tip 1404 of the writing instrument 1402 interacts with the work object in accordance with the design to draw a pattern on a surface of the work object, the pattern corresponding to the design.

In embodiments, the system is further configured such that the writing instrument 1402 is a marker configured to draw on the work object (e.g., 330A or 330B) based at least on the three-dimensional path relative to the position of and the orientation of the work object (e.g., 330A or 330B).

In embodiments, the system is further configured such that the structure 300 comprises at least one rail 302.

In embodiments, the system is further configured such that the end effector 318 further comprises an end effector structure 404 and an instrument receptacle 406, wherein the instrument receptacle 406 is configured to hold the writing instrument 1402 such that a tip 1404 of the instrument 1402 extends past the instrument receptacle 406. Furthermore, the instrument receptacle 406 is configured to slide linearly relative to the end effector structure 404 upon an application of a compressive force to the tip 1404.

In embodiments, the system is further configured such that the writing instrument 1402 is slidably positioned within or relative to the structure 404, wherein when the tip 1404 is pressed against the work object (e.g., 330A or 330B) with a first compressive force, the writing instrument 1402 is subject to a lesser opposing compressive force and in response to the application of the first compressive force slides an amount into or relative to the structure 404 to prevent over-compression of the tip 1404 upon the tip 1404 contacting the work object (e.g., 330A or 330B).

In embodiments, the system is further configured such that each of one or more of the plurality of actuators (e.g., actuators 320, 322, 324, 326, and/or 328) comprises a step and direction motor 104A.

In embodiments, the system is further configured such that each step and direction motor 104A comprises an encoder. Further, the at least one processor 101 is further configured to: (1) access or generate design path information associated with at least one design path, wherein each of the at least one design path is located along a modelled or reference surface, wherein collectively the at least one design path matches the design relative to the modelled or reference surface except that the modelled or reference surface does not necessarily have a same position and/or a same orientation as the surface of the work object; repeatedly receive over time, from each step and direction motor 104A, encoder signals indicative of a current joint angle of a given joint, wherein, wherein said step and direction motor 104A is associated with a joint between two components driven by said step and direction motor 104A; (2) based at least on the encoder signals and at least one of (a) a known and/or ascertained position of the surface of the work object (e.g., work object 330A or 330B) or (b) a known and/or ascertained orientation of the surface of the work object (e.g., work object 330A or 330B), determine, over time, joint angle adjustments associated with each joint, each joint associated with a particular step and direction motor 104A, each joint angle adjustment of one joint angle corresponding to a step and direction for one of step and direction motors 104A; (3) based at least on the joint angle adjustments over time, output the at least one of the instructions or the signals that cause the plurality of actuators (e.g., actuators 320, 322, 324, 326, and/or 328) to collectively move the tip 1404 of the writing instrument 1402 along the three-dimensional path relative to the position of and the orientation of the work object (e.g., work object 330A or 330B); and (4) based at least on the joint angle adjustments over time, output the at least one of the instructions or the signals that cause the plurality of actuators (e.g., actuators 320, 322, 324, 326, and/or 328) to collectively move the tip 1404 of the writing instrument 1402 along the three-dimensional path relative to the position of and the orientation of the work object (e.g., work object 330A or 330B) in accordance with the design to draw the pattern 332 on the surface of the work object (e.g., work object 330A or 330B).

In embodiments, the system is further configured such that the design path information involve a design path in two or three spatial dimensions, wherein a conversion of the design path information to the joint angle adjustments of one or more joint angles over time results in the joint angle adjustments of at least three joint angles to produce continuous movement of the end effector 318 along the three-dimensional path, wherein a quantity of the at least three joint angles is greater than a quantity of the two or three spatial dimensions for the design path.

In embodiments, the system is further configured such that the at least one processor is further configured to: (1) obtain boundary information corresponding to a two or three dimensional boundary that the plurality of arm segments (e.g., the first arm segment 312, the second arm segment 314, and the terminal arm segment 316) and the end effector 318 are disallowed from breaching; (2) receive encoder signals indicative of current joint angles of given actuators of the plurality of actuators (e.g., actuators 320, 322, 324, 326, and/or 328); (3) based at least on an upper angular bound and/or lower angular bound of a joint angle for each of the plurality of actuators and on the encoder signals, output the at least one of the instructions or the signals that cause the plurality of actuators to collectively move the tip 1404 of the writing instrument 1402 along the three-dimensional path relative to the position of and the orientation of the work object (e.g., work object 330A or 330B) while restricting the plurality of arm segments and the end effector 318 from breaching the two or three dimensional boundary.

In embodiments, the system further comprises at least one conveyor (e.g., track 902), the at least one conveyor configured to move the work object (e.g., work object 330A or 330B) through at least one boundary of the boundary information.

In embodiments, the system is further configured such that the at least one conveyor (e.g., track 902) comprises two conveyors, the two conveyors including a first conveyor positioned along a first side of the structure 300 and a second conveyor positioned along a second side of the structure 300, the second side opposite the first side of the structure 300.

In embodiments, the system is further configured such that the plurality of actuators (e.g., actuators 320, 322, 324, 326, and/or 328) is further collectively configured to rotate the end effector 318 relative to the terminal arm segment 316 about a fifth axis, the fifth axis (a) passing through the terminal arm segment 316 or (b) being parallel to the writing instrument 1402.

In embodiments, the system is further configured such that the second arm segment 314 comprises a first subsegment and a second subsegment, wherein the first subsegment is connected, via a subsegment joint, to the second subsegment, wherein the subsegment joint allows the second subsegment to move with at least one degree of freedom relative to the first subsegment, wherein the plurality of actuators (e.g., actuators 320, 322, 324, 326, and/or 328) is further collectively configured to rotate the second subsegment relative to the first subsegment about a sixth axis, the sixth axis being colinear with the second arm segment 314.

In embodiments, the system further comprises one or more sensors 804 communicatively coupled with the at least one processor 101, wherein the one or more sensors 804 are positioned to and configured to sense at least one of the work object (e.g., work object 330A or 330B), an object, animal, or person at least one position relative to one or more of the plurality of arm segments (e.g., the first arm segment 312, the second arm segment 314, and the terminal arm segment 316), the end effector 318, or the structure 300.

In embodiments, the system is further configured such that the at least one processor 101 is further configured to: (1) receive at least one of data or signals from each of the one or more sensors 804, wherein the received data or signals indicate that any of the object, the animal, or the person is at any of the at least one position; (2) based at least on (a) the received data or the received signals from any of the one or more sensors 804 or (b) a lack of received data or received signals from any of the one or more sensors 804, at least one of: (i) determine an occurrence of a possible incursion into a predetermined restricted safety zone by a given object, animal, or person; (ii) output at least one of overriding instructions or overriding signals that cause the plurality of actuators (e.g., actuators 320, 322, 324, 326, and/or 328) to collectively move the tip 1404 of the writing instrument 1402, the plurality of arm segments (e.g., the first arm segment 312, the second arm segment 314, and the terminal arm segment 316), and/or the arm base assembly 1104 to a predetermined position and orientation; (iii) output at least one of halt instructions or halt signals that cause a halting of operation of the plurality of actuators; or (iv) halt output of any instructions or signals to the plurality of actuators so as to cause the halting of operation of the plurality of actuators.

In some embodiments, the system further comprises one or more sensors 804 communicatively coupled with the at least one processor 101, wherein at least one sensor 804 of the one or more sensors is positioned to sense at least one of a reference feature and/or at least one reference point on the work object (e.g., work object 330A or 330B), wherein the at least one reference feature and/or the at least one reference point are indicative of at least one of (a) a position and/or orientation of the work object or (b) an origin point.

In some embodiments, the system is further configured such that the at least one processor 101 is further configured to: (1) output the at least one of the instructions or the signals that cause the plurality of actuators (e.g., actuators 320, 322, 324, 326, and/or 328) to synchronously and collectively move the tip 1404 of the writing instrument 1402 along the three-dimensional path relative to the position of and the orientation of the work object (e.g., work object 330A or 330B) such that the tip 1404 of the writing instrument 1402 interacts with the work object in accordance with the design to draw the pattern 332 on the surface of the work object, wherein multiple actuators of the plurality of actuators are simultaneously operated to achieve synchronous and collective movement of the tip 1404 of the writing instrument 1402 along the three-dimensional path relative to the position of and the orientation of the work object.

In some embodiments, the system is further configured such that the work object (e.g., work object 330A or 330B) has at least one flat surface, wherein the design is associated with a two-dimensional pattern to be drawn on one or more of the at least one flat surface of the work object.

In some embodiments, the system is further configured such that the design is associated with a railing outline pattern to be drawn on the work object (e.g., work object 330A or 330B).

In some embodiments, the system is further configured such that the work object (e.g., work object 330A or 330B) has at least one curved surface, wherein the design is associated with a pattern 332 to be drawn on one or more of the at least one curved surface of the work object.

In some embodiments, the system is further configured such that the structure 300 has a first side and a second side, wherein one or more of the plurality of actuators (e.g., actuators 320, 322, 324, 326, and/or 328) are further collectively configured at least to move a position of the end effector 318 from a first space adjacent the first side of the structure 300 to a second space adjacent to a second side of the structure 300. Further, the work object (e.g., work object 330A or 330B) is positioned in the first space, wherein the second work object (e.g., work object 330A or 330B) is positioned in the second work space. Furthermore, the at least one processor 101 is further configured to: (1) access second data associated with a second design; and output at least one of instructions or signals that cause the plurality of actuators to collectively move the tip 1404 of the writing instrument 1402 along a second three-dimensional path relative to a position of and an orientation of the second work object such that the tip 1404 of the writing instrument 1402 interacts with the second work object in accordance with the second design to draw a second pattern on a second object surface of the second work object, the second pattern corresponding to the second design.

In some embodiments, the system is configured such the structure 300 has a first side and a second side, wherein the work object (e.g., work object 330A or 330B) is supported by at least one positionable support structure (e.g., positionable table 1004A, 1004B, 1004C, 1004D), wherein the at least one positionable support structure is configured be moved relative to the structure 300.

In some embodiments, the system is configures such that the structure 300 has a first side and a second side, wherein one or more of the plurality of actuators (e.g., actuators 320, 322, 324, 326, and/or 328) are further collectively configured at least to move a position of the end effector 318 from a first space adjacent the first side of the structure 300 to a second space adjacent to a second side of the structure 300, wherein a second work object (e.g., work object 330A or 330B) is positioned in the second space and is supported by at least one other positionable support structure (e.g., positionable table 1004A, 1004B, 1004C, 1004D), wherein the at least one other positionable support structure is configured be moved relative to the structure 300.

As used throughout and as would be appreciated by those skilled in the art, “at least one non-transitory computer-readable medium” may refer to as at least one non-transitory computer-readable medium (e.g., at least one computer-readable medium implemented as hardware; e.g., at least one non-transitory processor-readable medium, at least one memory (e.g., at least one nonvolatile memory, at least one volatile memory, or a combination thereof; e.g., at least one random-access memory, at least one flash memory, at least one read-only memory (ROM) (e.g., at least one electrically erasable programmable ROM (EEPROM), at least one on-processor memory (e.g., at least one on-processor cache, at least one on-processor buffer, at least one on-processor flash memory, at least one on-processor EEPROM, or a combination thereof), or a combination thereof), at least one storage device (e.g., at least one hard-disk drive, at least one tape drive, at least one solid-state drive, at least one flash drive, at least one readable and/or writable disk of at least one optical drive configured to read from and/or write to the at least one readable and/or writable disk, or a combination thereof), or a combination thereof.

As used throughout, “at least one” means one or a plurality of; for example, “at least one” may comprise one, two, three, …, one hundred, or more. Similarly, as used throughout, “one or more” means one or a plurality of; for example, “one or more” may comprise one, two, three, …, one hundred, or more. Further, as used throughout, “zero or more” means zero, one, or a plurality of; for example, “zero or more” may comprise zero, one, two, three, …, one hundred, or more.

In the present disclosure, the methods, operations, and/or functionality disclosed may be implemented as sets of instructions or software readable by a device. Further, it is understood that the specific order or hierarchy of steps in the methods, operations, and/or functionality disclosed are examples of exemplary approaches. Based upon design preferences, it is understood that the specific order or hierarchy of steps in the methods, operations, and/or functionality can be rearranged while remaining within the scope of the inventive concepts disclosed herein. The accompanying claims may present elements of the various steps in a sample order, and are not necessarily meant to be limited to the specific order or hierarchy presented.

It is to be understood that embodiments of the methods according to the inventive concepts disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

From the above description, it is clear that the inventive concepts disclosed herein are well adapted to carry out the objects and to attain the advantages mentioned herein as well as those inherent in the inventive concepts disclosed herein. While presently preferred embodiments of the inventive concepts disclosed herein have been described for purposes of this disclosure, it will be understood that numerous changes may be made which will readily suggest themselves to those skilled in the art and which are accomplished within the broad scope and coverage of the inventive concepts disclosed and claimed herein.

What is claimed is:

1. A system, comprising:
a plurality of arm segments including a first arm segment, a second arm segment, and a terminal arm segment, wherein each arm segment of the plurality of arm segments is connected, via at least one arm segment joint, to at least one adjacent arm segment of the plurality of arm segments, wherein each of said at least one arm segment joints allows a given arm segment of the plurality of arm segments to move with at least one degree of freedom relative to a given adjacent arm segment that is adjacent the given arm segment, wherein said at least one arm segment joints includes a first arm segment joint and a terminal arm segment joint, wherein the first arm segment joint connects the first arm segment and the second arm segment, wherein the terminal arm segment connects at the terminal arm segment joint;
an arm base assembly including a first arm base component and a second arm base component, wherein the arm base assembly is configured to travel along a structure, wherein the first arm base component is connected, via an arm base joint, to the second arm base component, wherein the arm base joint allows the second arm base component to move with at least one degree of freedom relative to the first arm base component, wherein the second arm base component is connected, via a joint, to the first arm segment, wherein the joint allows the first arm segment to move with at least one degree of freedom relative to the second arm base component;
an end effector connected to the terminal arm segment, the end effector comprising a writing instrument having a tip;
a plurality of actuators collectively configured at least to:
move the arm base assembly along the structure;
rotate the second arm base component relative to the first arm base component about a first axis passing through the second arm base component and the first arm base component;
move the first arm segment relative to the second arm base component about a second axis passing through the joint, wherein the first axis and the second axis are non-parallel;
move the second arm segment about a third axis passing through the first arm segment joint; and
move the terminal arm segment about a fourth axis passing through the terminal arm segment joint; and
at least one processor communicatively coupled at least with the plurality of actuators, wherein the at least one processor is configured to:
access data associated with a design; and
output at least one of instructions or signals that cause the plurality of actuators to collectively move the tip of the writing instrument along a three-dimensional path relative to a position of and an orientation of a work object such that the tip of the writing instrument interacts with the work object in accordance with the design to draw a pattern on a surface of the work object, the pattern corresponding to the design.

2. The system of claim 1, wherein the writing instrument is a marker configured to draw on the work object based at least on the three-dimensional path relative to the position of and the orientation of the work object.

3. The system of claim 2, wherein the structure comprises at least one rail.

4. The system of claim 1, wherein the end effector further comprises an end effector structure and an instrument receptacle, wherein the instrument receptacle is configure to hold the writing instrument such that a tip of the instrument extends past the instrument receptacle, wherein the instrument receptacle is configured to slide linearly relative to the end effector structure upon an application of a compressive force to the tip.

5. The system of claim 4, wherein the writing instrument is slidably positioned within or relative to the structure, wherein when the tip is pressed against the work object with a first compressive force, the writing instrument is subject to a lesser opposing compressive force and in response to the application of the first compressive force slides an amount into or relative to the structure to prevent over-compression of the tip upon the tip contacting the work object.

6. The system of claim 1, wherein each of one or more of the plurality of actuators comprises a step and direction motor.

7. The system of claim 6, wherein each step and direction motor comprises an encoder, wherein the at least one processor is further configured to: access or generate design path information associated with at least one design path, wherein each of the at least one design path is located along a modelled or reference surface, wherein collectively the at least one design path matches the design relative to the modelled or reference surface except that the modelled or reference surface does not necessarily have a same position and/or a same orientation as the surface of the work object; repeatedly receive over time, from each step and direction motor, encoder signals indicative of a current joint angle of a given joint, wherein, wherein said step and direction motor is associated with a joint between two components driven by said step and direction motor; based at least on the encoder signals and at least one of (a) a known and/or ascertained position of the surface of the work object or (b) a known and/or ascertained orientation of the surface of the work object, determine, over time, joint angle adjustments associated with each joint, each joint associated with a particular step and direction motor, each joint angle adjustment of one joint angle corresponding to a step and direction for one of step and direction motors; and based at least on the joint angle adjustments over time, output the at least one of the instructions or the signals that cause the plurality of actuators to collectively move the tip of the writing instrument along the three-dimensional path relative to the position of and the orientation of the work object; and based at least on the joint angle adjustments over time, output the at least one of the instructions or the signals that cause the plurality of actuators to collectively move the tip of the writing instrument along the three-dimensional path relative to the position of and the orientation of the work object in accordance with the design to draw the pattern on the surface of the work object.

8. The system of claim 7, wherein the design path information involve a design path in two or three spatial dimensions, wherein a conversion of the design path information to the joint angle adjustments of one or more joint angles over time results in the joint angle adjustments of at least three joint angles to produce continuous movement of the end effector along the three-dimensional path, wherein a quantity of the at least three joint angles is greater than a quantity of the two or three spatial dimensions for the design path.

9. The system of claim 8, wherein the at least one processor is further configured to: obtain boundary information corresponding to a two or three dimensional boundary that the plurality of arm segments and the end effector are disallowed from breaching; receive encoder signals indicative of current joint angles of given actuators of the plurality of actuators; based at least on an upper angular bound and/or lower angular bound of a joint angle for each of the plurality of actuators and on the encoder signals, output the at least one of the instructions or the signals that cause the plurality of actuators to collectively move the tip of the writing instrument along the three-dimensional path relative to the position of and the orientation of the work object while restricting the plurality of arm segments and the end effector from breaching the two or three dimensional boundary.

10. The system of claim 9, further comprising at least one conveyor, the at least one conveyor configured to move the work object through at least one boundary of the boundary information.

11. The system of claim 10, wherein the at least one conveyor comprises two conveyors, the two conveyors including a first conveyor positioned along a first side of the structure and a second conveyor positioned along a second side of the structure, the second side opposite the first side of the structure.

12. The system of claim 1, wherein the plurality of actuators is further collectively configured to rotate the end effector relative to the terminal arm segment about a fifth axis, the fifth axis (a) passing through the terminal arm segment or (b) being parallel to the writing instrument.

13. The system of claim 12, wherein the second arm segment comprises a first subsegment and a second subsegment, wherein the first subsegment is connected, via a subsegment joint, to the second subsegment, wherein the subsegment joint allows the second subsegment to move with at least one degree of freedom relative to the first subsegment, wherein the plurality of actuators is further collectively configured to rotate the second subsegment relative to the first subsegment about a sixth axis, the sixth axis being colinear with the second arm segment.

14. The system of claim 1, further comprising one or more sensors communicatively coupled with the at least one processor, wherein the one or more sensors are positioned to and configured to sense at least one of the work object, an object, animal, or person at least one position relative to one or more of the plurality of arm segments, the end effector, or the structure.

15. The system of claim 14, wherein the at least one processor is further configured to: receive at least one of data or signals from each of the one or more sensors, wherein the received data or signals indicate that any of the object, the animal, or the person is at any of the at least one position; based at least on (a) the received data or the received signals from any of the one or more sensors or (b) a lack of received data or received signals from any of the one or more sensors, at least one of: (i) determine an occurrence of a possible incursion into a predetermined restricted safety zone by a given object, animal, or person; (ii) output at least one of overriding instructions or overriding signals that cause the plurality of actuators to collectively move the tip of the writing instrument, the plurality of arm segments, and/or the arm base assembly to a predetermined position and orientation; (iii) output at least one of halt instructions or halt signals that cause a halting of operation of the plurality of actuators; or (iv) halt output of any instructions or signals to the plurality of actuators so as to cause the halting of operation of the plurality of actuators.

16. The system of claim 1, further comprising one or more sensors communicatively coupled with the at least one processor, wherein at least one sensor of the one or more sensors is positioned to sense at least one of a reference feature and/or at least one reference point on the work object, wherein the at least one reference feature and/or the at least one reference point are indicative of at least one of (a) a position and/or orientation of the work object or (b) an origin point.

17. The system of claim 1, wherein the at least one processor is further configured to: output the at least one of the instructions or the signals that cause the plurality of actuators to synchronously and collectively move the tip of the writing instrument along the three-dimensional path relative to the position of and the orientation of the work object such that the tip of the writing instrument interacts with the work object in accordance with the design to draw the pattern on the surface of the work object, wherein multiple actuators of the plurality of actuators are simultaneously operated to achieve synchronous and collective movement of the tip of the writing instrument along the three-dimensional path relative to the position of and the orientation of the work object.

18. The system of claim 17, wherein the work object has at least one flat surface, wherein the design is associated with a two-dimensional pattern to be drawn on one or more of the at least one flat surface of the work object.

19. The system of claim 18 wherein the design is associated with a railing outline pattern to be drawn on the work object.

20. The system of claim 17, wherein the work object has at least one curved surface, wherein the design is associated with a pattern to be drawn on one or more of the at least one curved surface of the work object.

21. The system of claim 17, wherein the structure has a first side and a second side, wherein one or more of the plurality of actuators are further collectively configured at least to move a position of the end effector from a first space adjacent the first side of the structure to a second space adjacent to a second side of the structure, wherein the work object is positioned in the first space, wherein the second work object is positioned in the second work space, wherein the at least one processor is further configured to: access second data associated with a second design; and output at least one of instructions or signals that cause the plurality of actuators to collectively move the tip of the writing instrument along a second three-dimensional path relative to a position of and an orientation of the second work object such that the tip of the writing instrument interacts with the second work object in accordance with the second design to draw a second pattern on a second object surface of the second work object, the second pattern corresponding to the second design.

22. The system of claim 17, wherein the structure has a first side and a second side, wherein the work object is supported by at least one positionable support structure, wherein the at least one positionable support structure is configured be moved relative to the structure.

23. The system of claim 17, wherein the structure has a first side and a second side, wherein one or more of the plurality of actuators are further collectively configured at least to move a position of the end effector from a first space adjacent the first side of the structure to a second space adjacent to a second side of the structure, wherein a second work object is positioned in the second space and is supported by at least one other positionable support structure, wherein the at least one other positionable support structure is configured be moved relative to the structure.
